(19) United States
(12) Patent Application Publication
(10) Pub. No.: US 2010/0075233 A1
(43) Pub. Date: Mar. 25, 2010

(54) BATTERY AND ELECTRODE

(75) Inventors: Hiroyuki Yamaguchi, Fukushima (JP); Shunsuke Saito, Fukushima (JP); Toru Odani, Fukushima (JP); Masayuki Ihara, Fukushima (JP); Tadahiko Kubota, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/565,330

(22) Filed: Sep. 23, 2009

(30) Foreign Application Priority Data
Sep. 25, 2008 (JP) P2008-246493

(51) Int. Cl. H01M 6/16; H01M 4/02

(52) U.S. Cl. 429/338; 429/209

(57) ABSTRACT

A positive electrode includes: a salt represented by the following formula (1) on the surface of an active material contained in a positive electrode active material layer provided on a positive electrode collector, or at least on the surface of the positive electrode active material layer

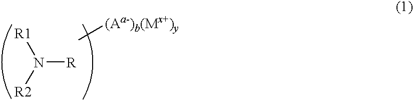

wherein R represents a hydrocarbon group which may have an unsaturated bond, a group obtained by halogenating or hydroxylating this hydrocarbon group, or a hydrogen group; R¹ and R² each independently represents an unsaturated bond, a hydrocarbon group which may have N or O, R¹ and R² may be bonded to each other to form a ring, in which the ring may further contain N or O, or a hydrogen group; A^{a-} represents an acid anion capable of being bonded to at least any one of R, R¹, R² and the ring; M^{x-} represents a metal ion capable of forming a salt together with A^{a-}; and a, b, x and y each represents an integer of 1 or more.

### CROSS REFERENCES TO RELATED APPLICATIONS

The present application claims priority to Japanese Priority Patent Application JP 2008-246493 filed in the Japan Patent Office on Sep. 25, 2008, the entire contents of which is hereby incorporated by reference.

### BACKGROUND

The present application relates to a positive electrode having a positive electrode active material layer on a positive electrode collector and a battery provided with the positive electrode.

In recent years, portable electronic appliances such as a camera-integrated VTR (video tape recorder), a mobile phone and a laptop personal computer have widely diffused, and it is strongly demanded to reduce their size and weight and to achieve their long life. Following this, batteries, in particular, light-weight secondary batteries capable of providing a high energy density have been developed as a power source.

Above all, a secondary battery utilizing intercalation and deintercalation of lithium (Li) for a charge and discharge reaction (so-called “lithium ion secondary battery”) is greatly expected because it is able to provide a higher energy density than a lead battery or a nickel-cadmium battery. Such a lithium ion secondary battery is provided with an electrolytic solution as well as a positive electrode and a negative electrode, and the negative electrode has a negative electrode active material layer on a negative electrode collector.

A carbon material such as graphite is widely used as a negative electrode active material to be contained in the negative electrode active material layer. Also, in recent years, following the development of a high performance and a multi-function of portable electronic appliances, a more enhancement of the battery capacity is demanded. Thus, it is investigated to use silicon, tin or the like instead of the carbon material. This is because a theoretical capacity of silicon (4,199 mAh/g) and a theoretical capacity of tin (994 mAh/g) are significantly higher than a theoretical capacity of graphite (372 mAh/g), and therefore, a large enhancement of the battery capacity can be expected.

However, in the lithium ion secondary battery, the negative electrode active material having lithium intercalated therein becomes highly active at the time of charge and discharge, and therefore, not only the electrolytic solution is easily decomposed, but lithium is easily deactivated. Thus, a sufficient cycle characteristic is hardly obtained. In the case of using, as a negative electrode active material, silicon with a high theoretical capacity or the like, this problem becomes conspicuous.

Then, in order to solve various problems of the lithium ion secondary battery, there have been made a number of investigations. Specifically, in order to enhance a negative electrode characteristic and a low-temperature characteristic, there is proposed a technology for incorporating a phenylsulfonic acid metal salt into an electrolytic solution (see, for example, JP-A-2002-056891). Also, in order to enhance battery characteristics, there is proposed a technology for incorporating an organic alkali metal salt into an electrolytic solution (see, for example, JP-A-2000-268863). Furthermore, in order to enhance a storage characteristic and a cycle characteristic, there is proposed a technology for incorporating a hydroxycarboxylic acid into an electrolytic solution (see, for example, JP-A-2003-092137). In addition to this, in order to suppress a lowering of the battery capacity, there is proposed a technology for coating a carbon material which is a negative electrode active material with a lithium alkoxide compound (see, for example, JP-A-08-138745). Also, there is proposed a technology for adding a nitrogen compound to a positive electrode, thereby enhancing electric conductivity (see, for example, JP-A-09-237624). Besides, there is proposed a technology for adding an amine for the purpose of removing an acid in an electrolytic solution (see, for example, JP-A-2001-167790).

In recent years, portable electronic appliances have widely diffused over wide-ranging fields, and there is a possibility that a secondary battery is exposed in a high-temperature atmosphere at the time of transportation, the time of use or the time of carrying or the like. Thus, the secondary battery is in a state where it is easy to swell. In view of these facts, a much more enhancement regarding a swelling characteristic of the secondary battery is desirable.

### SUMMARY

It is desirable to provide a positive electrode capable of suppressing swelling at the time of high-temperature storage without lowering a cycle characteristic, a battery and a manufacturing method of the same.

Embodiments according to the present application are as follows.

(1) A positive electrode including a salt represented by the following formula (1) on the surface of an active material contained in a positive electrode active material layer provided on a positive electrode collector, or at least on the surface of the positive electrode active material layer.

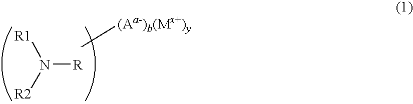

In the foregoing formula (1), R represents a hydrocarbon group which may have an unsaturated bond, a group obtained by halogenating or hydroxylating this hydrocarbon group, or a hydrogen group; R1 and R2 each independently represents an unsaturated bond, a hydrocarbon group which may have N or O, R1 and R2 may be bonded to each other to form a ring, in which the ring may further contain N or O, or a hydrogen group; A^{a-} represents an acid anion capable of being bonded to at least any one of R, R1, R2 and the ring; M^{x+} represents a metal ion capable of forming a salt together with A^{a-}; and a, b, x and y each represents an integer of 1 or more.

(2) A battery including an electrolytic solution as well as a positive electrode and a negative electrode having a negative electrode active material layer provided on a negative electrode collector, wherein the positive electrode is the positive electrode as set forth above in (1).

In accordance with the positive electrode according to an embodiment, since the salt represented by the formula (1) is used for the positive electrode, chemical stability of the positive electrode is enhanced as compared with the case of not using the subject salt. For that reason, not only an electrode reactant is efficiently intercalated and deintercalated in the positive electrode, but the positive electrode hardly reacts with other materials such as the electrolytic solution. According to this, in accordance with the positive electrode and the battery using the subject positive electrode according to the embodiments, the gas generation at the time of high-temperature storage can be suppressed.

Additional features and advantages are described herein, and will be apparent from the following Detailed Description and the figures.

### BRIEF DESCRIPTION OF THE FIGURES

FIG. 1 is a sectional view showing a configuration of a secondary battery according to an embodiment.

FIG. 2 is a sectional view showing enlargedly a part of a wound electrode body in the secondary battery shown in FIG. 1.

FIG. 3 is an exploded perspective view showing a configuration of a non-aqueous electrolytic solution secondary battery according to an embodiment.

FIG. 4 is a sectional view showing a configuration along a VIII-VIII line of a wound electrode body shown in FIG. 3.

FIG. 5 is a sectional view showing enlargedly a part of a wound electrode body in the secondary battery shown in FIG. 3.

### DETAILED DESCRIPTION

The present application is described below with reference to the drawings according to an embodiment. The structure and substituents of the salt represented by the formula (1) which is used in an embodiment are hereunder described.

R is described.

R represents a hydrocarbon group which may have an unsaturated bond, a group obtained by halogenating or hydroxylating this hydrocarbon group, or a hydrogen group. Examples of the hydrocarbon group include a branched, linear or cyclic alkyl group, alkenyl group or alkynyl group each having from 1 to 20 carbon atoms and an aryl group or an aralkyl group each having from 6 to 28 carbon atoms.

R may be halogenated or hydroxylated, and the both may be modified. As the halogen atom, chlorine and fluorine are preferable.

R1 and R2 are described.

R1 and R2 each independently represents an unsaturated bond, a hydrocarbon group which may have N or O, R1 and R2 may be bonded to each other to form a ring, in which the ring may further contain N or O, or a hydrogen group. Examples of the hydrocarbon group include the same groups as those exemplified above for R. In the case where this hydrocarbon group contains N, amino group-containing hydrocarbon groups are preferable; and in the case where this hydrocarbon group contains O, hydroxyl group-containing hydrocarbon groups are preferable.

As the ring to be formed, 3-membered to 8-membered rings are preferable, and saturated rings are more preferable. Examples of a compound of the ring include piperidine, piperazine, morpholine, ethyleneimine, trimethyleneimine, hexamethyleneimine, octogen, pyrrole, imidazole, pyrazole, oxazole, isoxazole, pyridine, pyrazine and thiomorpholine.

A^{a-} and M^{x+} are described.

A^{a-} represents an acid anion capable of being bonded to at least any one of R, R1, R2 and the ring. Examples of the acid anion include various anions of sulfonic acid, carboxylic acid, sulfinic acid, phosphonic acid, phosphinic acid, etc. M^{x+} represents a metal ion capable of forming a salt together with A^{a-}. a, b, x and y each represents an integer of 1 or more. Though a bonding site of A^{a-} to the foregoing substituent is not particularly limited, A^{a-} is preferably bonded in an end of the chain moiety or on the ring.

b is preferably from 1 to 6, and more preferably from 1 to 4. M is preferably a metal belonging to the Group 1 or the Group 2 of the periodic table. Accordingly, x is preferably 1 or 2.

Specific examples of the salt represented by the formula (1) are given below, but it should not be construed that an embodiment according to the present application is limited thereto.

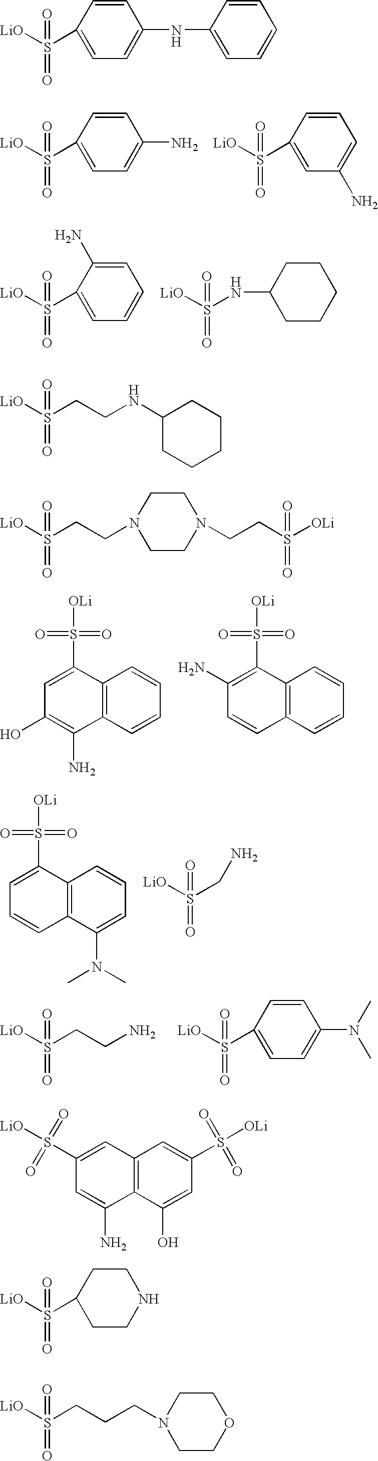

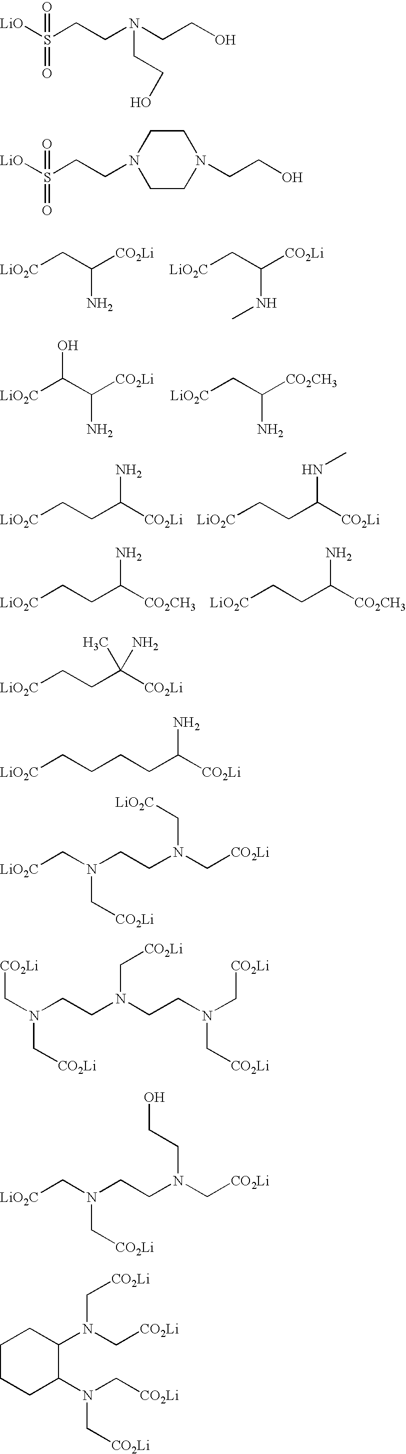

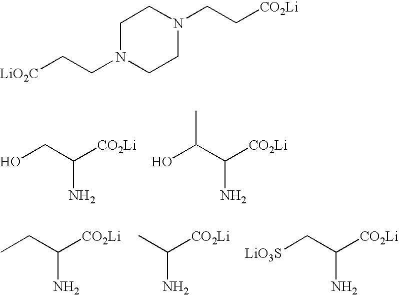

While examples wherein M is lithium have been described above, elements belonging to the Group I such as sodium and potassium and elements belonging to the Group II such as magnesium, calcium and barium can also be used. Also, while examples of a sulfonic acid salt and a carboxylic acid salt have been exemplified above, a sulfinic acid salt, a phosphonic acid salt, a phosphinic acid, etc. can be used.

In accordance with the salt represented by the formula (1) according to an embodiment, chemical stability on the electrode is enhanced through a reaction with an active reaction species formed within an electrochemical device. Accordingly, the salt represented by the formula (1) is able to contribute to an enhancement of electrical performances of the electrochemical device. More specifically, in the case where this metal salt is used in a secondary battery as the electrochemical device, it is able to suppress swelling at the time of high-temperature storage of a positive electrode.

In particular, when used for the positive electrode, the salt represented by the formula (1) is stable because its solubility is suppressed. Also, in the case where the salt represented by the formula (1) is used in an electrochemical device together with an organic solvent, etc., it is able to stably display a function to enhance chemical stability, for example, prevention of decomposition of an electrolytic solution or dropping off or dissolution of an electrode film.

Embodiments are hereunder described in detail with reference to the accompanying drawings.

The salt represented by the formula (1) according to an embodiment is used for an electrochemical device, for example, secondary batteries and is an amino group-containing metal salt (the salt represented by the formula (1) will be hereinafter referred to as “metal salt”). In the case where this metal salt is used for an electrochemical device, for example, it may be formed as a film on the surface of a solid such as an electrode and a positive electrode active material or may be dispersed in a positive electrode.

In view of the fact that this metal salt contains an amino group, since it is stabilized in a film, etc. through a reaction with an active reaction species, it contributes to an enhancement of electrochemical performances of the electrochemical device; and since its solubility in an electrolytic solution is low, it is able to retain on the electrode without being dissolved in the electrolytic solution, thereby keeping up the effects.

Next, use examples of the foregoing metal salt are described. When a secondary battery is given as an example of the electrochemical device, the metal salt is used in the secondary battery as follows.

The secondary battery as described herein is a lithium ion secondary battery which is provided with a positive electrode and a negative electrode opposing to each other via a separator and an electrolytic solution and in which, for example, a capacity of the negative electrode is expressed on the basis of intercalation and deintercalation of lithium which is an electrode reactant. The positive electrode has a positive electrode active material layer on a positive electrode collector, and the negative electrode has a negative electrode active material layer on a negative electrode collector. The electrolytic solution contains a solvent and an electrolyte salt dissolved therein.

In this secondary battery, the positive electrode contains the foregoing metal salt. This is because the chemical stability of the electrode is enhanced by the metal salt, and therefore, a decomposition reaction of the electrolytic solution is suppressed.

The kind (battery structure) of this secondary battery is not particularly limited. With respect to the case where the positive electrode contains the metal salt, a detailed configuration of the secondary battery is hereunder described while referring to a cylinder type and a laminated film type as an example of the battery structure.

(First Secondary Battery)

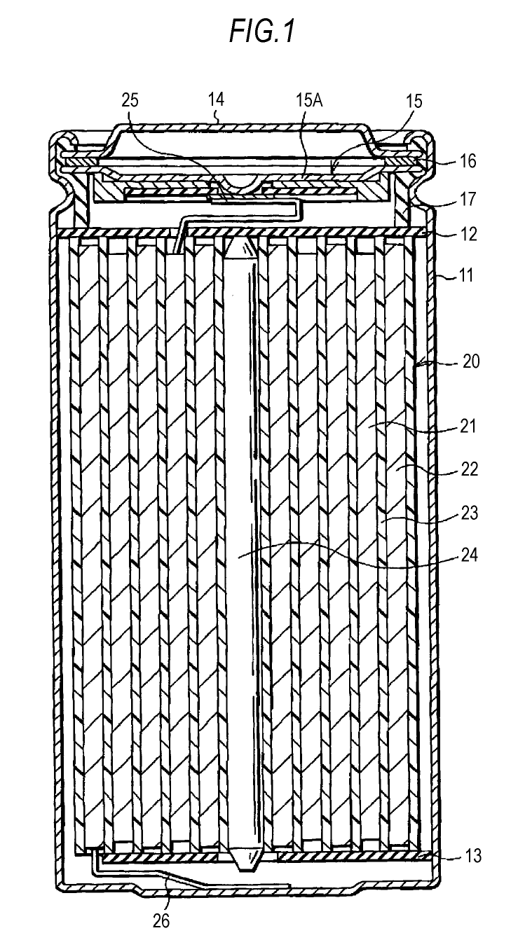

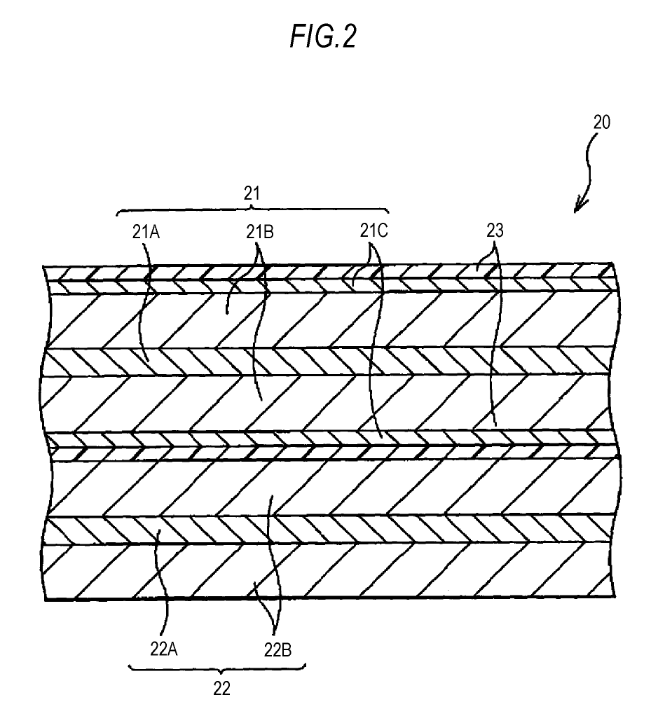

FIGS. 1 and 2 each shows a sectional configuration of a first secondary battery, and FIG. 2 shows enlargedly a part of a wound electrode body 20 shown in FIG. 1.

This secondary battery is chiefly one in which a wound electrode body 20 having a positive electrode 21 and a negative electrode 22 wound therein via a separator 23 and a pair of insulating plates 12 and 13 are housed in the inside of a substantially hollow columnar battery can 11. The battery structure using this columnar battery can 11 is called a cylinder type.

For example, the battery can 11 has a hollow structure in which one end thereof is closed, with the other end being opened and is made of a metal material such as iron, aluminum and alloys thereof. In the case where the battery can 11 is made of iron, it may be plated with, for example, nickel, etc. The pair of the insulating plates 12 and 13 is disposed so as to vertically interpose the wound electrode body 20 therebetween and vertically extend relative to the wound peripheral surface thereof.

In the open end of the battery can 11, a battery lid 14 and a safety valve mechanism 15 and a positive temperature coefficient element (PTC element) 16 each provided on the inside of this battery lid 14 are installed by caulking via a gasket 17. According to this, the inside of the battery can 11 is hermetically sealed. The battery lid 14 is made of, for example, a material the same as that in the battery can 11. The safety valve mechanism 15 is electrically connected to the battery lid 14 via the positive temperature coefficient element 16. In this safety valve mechanism 15, in the case where the internal pressure reaches a fixed value or more due to an internal short circuit or heating from the outside or the like, a disc plate 15A is reversed, whereby electrical connection between the battery lid 14 and the wound electrode body 20 is disconnected. In view of the fact that the resistance increases corresponding to a rise of the temperature, the positive temperature coefficient element 16 controls the current, thereby preventing abnormal heat generation to be caused due to a large current. The gasket 17 is made of, for example, an insulating material, and asphalt is coated on the surface thereof.

A center pin 24 may be inserted in the center of the wound electrode body 20. In this wound electrode body 20, a positive electrode lead 25 made of a metal material such as aluminum is connected to the positive electrode 21; and a negative electrode lead 26 made of a metal material such as nickel is connected to the negative electrode 22. The positive electrode lead 25 is electrically connected to the battery lid 14 by means of welding to the safety valve mechanism 15 or other means; and the negative electrode lead 26 is electrically connected to the battery can 11 by means of welding or other means.

The positive electrode 21 is, for example, one in which a positive electrode active material layer 21B is provided on the both surfaces of a positive electrode collector 21A having a pair of surfaces. However, the positive electrode active material layer 21B may be provided on only one surface of the positive electrode collector 21A.

The positive electrode collector 21A is made of a metal material, for example, aluminum, nickel, stainless steel, etc.

The positive electrode active material layer 21B contains, as a positive electrode active material, one or two or more kinds of a positive electrode material capable of intercalating and deintercalating lithium and may contain other materials such as a binder and a conductive agent as the need arises.

As the positive electrode material capable of intercalating and deintercalating lithium, for example, a lithium-containing compound is preferable. This is because a high energy density is obtained. Examples of this lithium-containing compound include complex oxides containing lithium and a transition metal element and phosphate compounds containing lithium and a transition metal element. Of these, compounds containing, as the transition metal element, at least one member selected from the group consisting of cobalt, nickel, manganese and iron are preferable. This is because a higher voltage is obtained. A chemical formula thereof is, for example, represented by LiₓMIO₂ or Li_{y}M2PO₄. In these formulae, M1 and M2 each represents at least one transition metal element. Values of x and y vary depending upon the state of charge and discharge and are usually satisfied with relations of 0.05≦x≦1.10 and 0.05≦y≦1.10, respectively.

Specific examples of the complex oxide containing lithium and a transition metal element include a lithium cobalt complex oxide (LiₓCoO₂), a lithium nickel complex oxide (LiₓNiO₂), a lithium nickel cobalt complex oxide (LiₓNi_{1-z}CO_{z}O₂ (z<1)), a lithium nickel cobalt manganese complex oxide (LiₓNi_{(1-v-w)}CoᵥMn_{w}O₂ ((v+w)<1)) and a lithium manganese complex oxide having a spinel type structure (LiMn₂O₄). Of these, cobalt-containing complex oxides are preferable. This is because not only a high capacity is obtained, but an excellent cycle characteristic is obtained. Also, examples of the phosphate compound containing lithium and a transition metal element include a lithium iron phosphate compound (LiFePO₄) and a lithium iron manganese phosphate compound (LiFe₁₋ᵤMnᵤPO₄ (u<1)).

In addition to this, examples of the positive electrode material capable of intercalating and deintercalating lithium include oxides such as titanium oxide, vanadium oxide and manganese dioxide; disulfides such as titanium disulfide and molybdenum disulfide; chalcogenides such as niobium selenide; sulfur; and conductive polymers such as polyaniline and polythiophene.

As a matter of course, the positive electrode material capable of intercalating and deintercalating lithium may be a material other than those described above. Also, the foregoing series of positive electrode materials may be a mixture of two or more kinds thereof in an arbitrary combination.

The positive electrode active material is provided with a film of the metal salt. The reason why this film is provided on the positive electrode active material resides in the fact that the chemical stability of the positive electrode is enhanced, and following this, the chemical stability of the electrolytic solution adjacent to the positive electrode is also enhanced. According to this, not only lithium is efficiently intercalated and deintercalated in the positive electrode, but a decomposition reaction of the electrolytic solution is suppressed, whereby the cycle characteristic is enhanced.

This film may be provided so as to cover the entire surface of the positive electrode active material, or may be provided so as to cover a part of the surface thereof.

Examples of a method for providing the film include a liquid phase process such as a dipping process; and a vapor phase process such as a vapor deposition process, a sputtering process and a CVD (chemical vapor deposition) process. These processes may be adopted singly, or two or more processes may be adopted jointly. Of these, it is preferred to provide a positive electrode film 21C by using a solution containing the foregoing metal salt by the liquid phase process. Specifically, for example, in the dipping process, the positive electrode active material is dipped in a solution containing the metal salt and subsequently dried, thereby coating the metal salt on the surface of the positive electrode active material. This is because a good film having high chemical stability can be easily provided. Examples of a solvent which dissolves the metal salt therein include solvents with high polarity, such as water.

Examples of the conductive agent include carbon materials such as graphite, carbon black, acetylene black and ketjen black. These carbon materials may be used singly or in admixture of plural kinds thereof. The conductive agent may be a metal material or a conductive polymer so far as it is a material having conductivity.

Examples of the binder include synthetic rubbers such as styrene-butadiene based rubbers, fluorine based rubbers and ethylene-propylene-diene based rubbers; and polymer materials such as polyvinylidene fluoride. These binders may be used singly or in admixture of plural kinds thereof.

The negative electrode 22 is, for example, one in which a negative electrode active material layer 22B is provided on the both surfaces of a negative electrode collector 22A having a pair of surfaces. However, the negative electrode active material layer 22B may be provided on only one surface of the negative electrode collector 22A.

The negative electrode collector 22A is made of a metal material, for example, copper, nickel, stainless steel, etc. It is preferable that the surface of this negative electrode collector 22A is roughed. This is because adhesion between the negative electrode collector 22A and the negative electrode active material layer 22B is enhanced due to a so-called anchor effect. In that case, the surface of the negative electrode collector 22A may be roughed in at least a region opposing to the negative electrode active material layer 22B. Examples of a method for achieving roughing include a method for forming fine particles by an electrolysis treatment. The electrolysis treatment as referred to herein is a method in which fine particles are formed on the surface of the negative electrode collector 22A in an electrolysis vessel by means of electrolysis, thereby provides recesses and projections. A copper foil having this electrolysis treatment applied thereto is generally named as “electrolytic copper foil”.

The negative electrode active material layer 22B contains, as a negative electrode active material, one or two or more kinds of a negative electrode material capable of intercalating and deintercalating lithium and may contain other materials such as a binder and a conductive agent as the need arises. Details regarding the binder and the conductive agent are, for example, the same as those in the case of explaining the positive electrode 21.

Examples of the negative electrode material capable of intercalating and deintercalating lithium include materials capable of intercalating and deintercalating lithium and containing, as a constituent element, at least one member selected from the group consisting of metal elements and semi-metal elements. This is because a high energy density is obtained. Such a negative electrode material may be a simple substance, an alloy or a compound of a metal element or a semi-metal element, or may be one containing one or two or more phases of the metal element or semi-metal element in at least a part thereof. In an embodiment according to the application, the “alloy” as referred to herein includes alloys containing at least one member of a metal element and at least one member of a semi-metal element in addition to alloys composed of two or more kinds of metal elements. Also, the “alloy” may contain a non-metal element. Examples of its texture include a solid solution, a eutectic (eutectic mixture), an intermetallic compound and one in which two or more kinds thereof coexist.

Examples of the foregoing metal element or semi-metal element include metal elements or semi-metal elements capable of forming an alloy together with lithium. Specific examples thereof include magnesium, boron (B), aluminum, gallium (Ga), indium (In), silicon, germanium (Ge), tin, lead (Pb), bismuth (Bi), cadmium (Cd), silver (Ag), zinc, hafnium (Hf), zirconium (Zr), yttrium (Y), palladium (Pd) and platinum (Pt). Of these, at least one member of silicon and tin is preferable. This is because the ability to intercalate and deintercalate lithium is large so that a high energy density is obtained.

Examples of the negative electrode material containing at least one member of silicon and tin include a simple substance of silicon, an alloyed silicon, a silicon compound, a simple substance of tin, an alloyed tin and a tin compound and a material containing one or two or more kinds of phases thereof in at least a part thereof.

Examples of the alloy of silicon include alloys containing, as a second constituent element other than silicon, at least one member selected from the group consisting of tin, nickel, copper, iron, cobalt, manganese, zinc, indium, silver, titanium, germanium, bismuth, antimony (Sb) and chromium. Examples of the compound of silicon include compounds containing oxygen or carbon (C), and the compound of silicon may contain the foregoing second constituent element in addition to silicon. Examples of the alloy or compound of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi, WSi₂, ZnSi₂, SiC, Si₃N₄, Si₂N₂O, SiOᵥ (0<v≦2), SnO_{w} (0<w≦2) and LiSiO.

Examples of the alloy of tin include alloys containing, as a second constituent element other than tin, at least one member selected from the group consisting of silicon, nickel, copper, iron, cobalt, manganese, zinc, indium, silver, titanium, germanium, bismuth, antimony and chromium. Examples of the compound of tin include compounds containing oxygen or carbon, and the compound of tin may contain the foregoing second constituent element in addition to tin. Examples of the alloy or compound of tin include SnSiO₃, LiSnO and Mg₂Sn.

In particular, as the negative electrode material containing at least one member of silicon and tin, for example, those containing, in addition to tin as a first constituent element, second and third constituent elements are preferable. The second constituent element is at least one member selected from the group consisting of cobalt, iron, magnesium, titanium, vanadium (V), chromium, manganese, nickel, copper, zinc, gallium, zirconium, niobium (Nb), molybdenum, silver, indium, cerium (Ce), hafnium, tantalum (Ta), tungsten (W), bismuth and silicon. The third constituent element is at least one member selected from the group consisting of boron, carbon, aluminum and phosphorus (P). This is because in view of the fact that the negative electrode material contains the second and third constituent elements, the cycle characteristic is enhanced.

Above of all, the negative electrode material is preferably an SnCoC-containing material containing tin, cobalt and carbon as constituent elements and having a content of carbon of 9.9% by mass or more and not more than 29.7% by mass and a proportion of cobalt to the total sum of tin and cobalt (Co/(Sn+Co)) of 30% by mass or more and not more than 70% by mass. This is because a high energy density is obtained in the foregoing composition range.

This SnCoC-containing material may further contain other constituent elements as the need arises. As other constituent elements, for example, silicon, iron, nickel, chromium, indium, niobium, germanium, titanium, molybdenum, aluminum, phosphorus, gallium and bismuth are preferable. The SnCoC-containing material may contain two or more kinds of these elements. This is because a higher effect is obtained.

The SnCoC-containing material has a phase containing tin, cobalt and carbon, and this phase is preferably a lowly crystalline or amorphous phase. This phase is a reaction phase which is reactive with lithium, and an excellent cycle characteristic is obtained by this phase. In the case of using CuKα-rays as specified X-rays and defining a sweep rate at 1°/min, a half width value of a diffraction peak obtained by X-ray diffraction of this phase is preferably 1.0° or more in terms of a diffraction angle 2θ. This is because not only lithium is more smoothly intercalated and deintercalated, but the reactivity with an electrolyte is reduced.

Whether or not the diffraction peak obtained by the X-ray diffraction is corresponding to the reaction phase which is reactive with lithium can be easily determined by comparing an X-ray diffraction chart before and after an electrochemical reaction with lithium. For example, when a position of the diffraction peak changes before and after the electrochemical reaction with lithium, it is determined that the diffraction peak is corresponding to the reaction phase which is reactive with lithium. In that case, for example, a diffraction peak of a lowly crystalline or amorphous phase is observed in the range of from 20° and 50° in terms of 2θ. This lowly crystalline or amorphous phase contains, for example, the foregoing respective constituent elements, and it may be considered that this phase is lowly crystallized or amorphized chiefly by carbon.

There may be the case where the SnCoC-containing material has, in addition to the lowly crystalline or amorphous phase, a phase containing a simple substance or a part of each of the constituent elements.

In particular, in the SnCoC-containing material, it is preferable that at least a part of carbon as the constituent element is bonded to the metal element or semi-metal element as other constituent element. This is because cohesion or crystallization of tin or the like is suppressed.

Examples of a method for examining the bonding state of elements include X-ray photoelectron spectroscopy (XPS). This XPS is a method in which soft X-rays (using AlKα-rays or MgKα-rays in commercially available units) are irradiated on the surface of a sample, and kinetic energy of photoelectrons which fly out from the sample surface are measured, thereby examining an element composition and a bonding state of elements in a region of several nm from the sample surface.

The bound energy of an inner orbital electrode of an element changes in correlation with a charge density on the element from the standpoint of primary approximation. For example, in the case where the charge density of a carbon element is reduced due to an interaction with an element existing in the vicinity of the carbon element, an outer electron such as a 2p electron is reduced, and therefore, a 1s electron of the carbon element receives a strong constraining force from the shell. That is, when the charge density of an element is reduced, the constraining force becomes high. In XPS, when the bound energy increases, a peak is shifted into a high energy region.

In XPS, so far as graphite is concerned, a peak of a 1s orbit of carbon (C1s) appears at 284.5 eV in a unit in which the energy is calibrated such that a peak of a 4f orbit of a gold atom (Au4f) is obtained at 84.0 eV. Also, so far as the surface contamination carbon is concerned, the peak of C1s appears at 284.8 eV. On the other hand, in the case where the charge density of the carbon element becomes high, for example, when bonded to a more positive element than carbon, the peak of C1s appears in a lower region than 284.5 eV. That is, in the case where at least a part of carbons contained in the SnCoC-containing material is bonded to a metal element or a semi-metal element as other constituent element or the like, a peak of a composite wave of C1s obtained regarding the SnCoC-containing material appears in a lower region than 284.5 eV.

In the case of carrying out the XPS measurement, it is preferable that in covering the surface by the surface contamination carbon, the surface is lightly sputtered by an argon ion gun attached to the XPS unit. Also, in the case where the SnCoC-containing material to be measured exists in the negative electrode 22, it would be better that after taking apart the secondary battery, the negative electrode 22 is taken out and then rinsed with a volatile solvent such as dimethyl carbonate. This is made for the purpose of removing a solvent with low volatility and an electrolyte existing on the surface of the negative electrode 22. It is desirable that their sampling is carried out in an inert atmosphere.

Also, in the XPS measurement, for example, the peak of C1s is used for correcting the energy axis of a spectrum. In general, since the surface contamination carbon exists on the material surface, the peak of C1s of the surface contamination carbon is fixed at 284.8 eV and employed as an energy reference. In the XPS measurement, the waveform of the peak of C1s is obtained as a form including the peak of the surface contamination carbon and the peak of carbon in the SnCoC-containing material, and therefore, the peak of the surface contamination carbon and the peak of carbon in the SnCoC-containing material are separated by, for example, analysis using a commercially available software program. In the analysis of the waveform, a position of a main peak existing on the lowest bound energy side is employed as an energy reference (284.8 eV).

This SnCoC-containing material can be formed by, for example, melting a mixture obtained by mixing of raw materials of the respective constituent elements in an electric furnace, a high frequency induction furnace, an arc furnace, etc. and then solidifying the melt. Also, various atomizing processes such as gas atomization and water atomization, various rolling processes or processes utilizing a mechanochemical reaction such as a mechanical alloying process and a mechanical milling process may be adopted. Of these, a process utilizing a mechanochemical reaction is preferable. This is because the SnCoC-containing material is converted to have a lowly crystalline or amorphous structure. In the process utilizing a mechanochemical reaction, for example, a planetary ball mill unit or a manufacturing unit such as an attritor can be used.

For the raw material, though simple substances of the respective constituent elements may be mixed, it is preferred to use an alloy with respect to a part of the constituent elements other than carbon. This is because by adding carbon to such an alloy and synthesizing the raw material by a method utilizing a mechanical alloying process, a lowly crystalline or amorphous structure is obtained, and the reaction time is shortened, too. The form of the raw material may be a powder or a block.

In addition to this SnCoC-containing material, an SnCoFeC-containing material having tin, cobalt, iron and carbon as constituent elements is also preferable. A composition of this SnCoFeC-containing material can be arbitrarily set up. For example, in the case where a content of iron is set up low, a composition in which a content of carbon is 9.9% by mass or more and not more than 29.7% by mass, a content of iron is 0.3% by mass or more and not more than 5.9% by mass, and a proportion of cobalt to the total sum of tin and cobalt (Co/(Sn+Co)) is 30% by mass or more and not more than 70% by mass is preferable. Also, for example, in the case where a content of iron is set up high, a composition in which a content of carbon is 11.9% by mass or more and not more than 29.7% by mass, a proportion of the total sum of cobalt and iron to the total sum of tin, cobalt and iron ((Co+Fe)/(Sn+Co+Fe)) is 26.4% by mass or more and not more than 48.5% by mass, and a proportion of cobalt to the total sum of cobalt and iron (Co/(Co+Fe)) is 9.9% by mass or more and not more than 79.5% by mass is preferable. This is because a high energy density is obtained in the foregoing composition range. The crystallinity, measurement method, bonding state of elements and formation method of this SnCoFeC-containing material and the like are the same as in the foregoing SnCoC-containing material.

The negative electrode active material layer 22B using, as a negative electrode material capable of intercalating and deintercalating lithium, a simple substance of silicon, an alloyed silicon, a silicon compound, a simple substance of tin, an alloyed tin or a tin compound or a material containing one or two or more kinds of phases thereof in at least a part thereof is formed by, for example, a vapor phase process, a liquid phase process, a spraying process, a coating process, a baking process or a combined process of two or more kinds of these processes. In that case, it is preferable that the negative electrode collector 22A and the negative electrode active material layer 22B are alloyed on at least a part of the interface therebetween. In detail, on the interface between the both, the constituent elements of the negative electrode collector 22A may be diffused into the negative electrode active material layer 22B, the constituent elements of the negative electrode active material layer 22B may be diffused into the negative electrode collector 22A, or these constituent elements may be mutually diffused. This is because not only breakage to be caused due to expansion and shrinkage of the negative electrode active material layer 22B at the time of charge and discharge can be suppressed, but electron conductivity between the negative electrode collector 22A and the negative electrode active material layer 22B is enhanced.

Examples of the vapor phase process include a physical deposition process and a chemical deposition process, specifically a vacuum vapor deposition process, a sputtering process, an ion plating process, a laser abrasion process, a thermal chemical vapor deposition (CVD) process and a plasma chemical vapor deposition process. As the liquid phase process, known techniques such as electrolytic plating and non-electrolytic plating can be adopted. The coating process as referred to herein is, for example, a process in which after mixing a granular negative electrode active material with a binder and the like, the mixture is dispersed in a solvent and coated. The baking process as referred to herein is, for example, a process in which after coating by a coating process, the coated material is heat treated at a higher temperature than a melting point of the binder, etc. As to the baking process, known techniques can be utilized, and examples thereof include an atmospheric baking process, a reaction baking process and a hot press baking process.

In addition to the foregoing, examples of the negative electrode material capable of intercalating and deintercalating lithium include carbon materials. Examples of such a carbon material include easily graphitized carbon, hardly graphitized carbon with a (002) plane interval of 0.37 nm or more and graphite with a (002) plane interval of not more than 0.34 nm or more. More specifically, there are exemplified pyrolytic carbons, cokes, vitreous carbon fibers, organic polymer compound baked materials, active carbon and carbon blacks. Of these, examples of the cokes include pitch coke, needle coke and petroleum coke. The organic polymer compound baked material as referred to herein is a material obtained through carbonization by baking a phenol resin, a furan resin or the like at an appropriate temperature. The carbon material is preferable because a change in a crystal structure following the intercalation and deintercalation of lithium is very small, and therefore, a high energy density is obtained, an excellent cycle characteristic is obtained, and the carbon material also functions as a conductive agent. The shape of the carbon material may be any of a fibrous shape, a spherical shape, a granular shape or a flaky shape.

Also, examples of the negative electrode material capable of intercalating and deintercalating lithium include metal oxides and polymer compounds capable of intercalating and deintercalating lithium. Examples of the metal oxide include iron oxide, ruthenium oxide and molybdenum oxide; and examples of the polymer compound include polyacetylene, polyaniline and polypyrrole.

As a matter of course, the negative electrode material capable of intercalating and deintercalating lithium may be a material other than those described above. Also, the foregoing series of negative electrode materials may be a mixture of two or more kinds thereof in an arbitrary combination.

The negative electrode active material made of the foregoing negative electrode material is composed of plural granules. That is, the negative electrode active material layer 22B has plural negative electrode active material particles, and the negative electrode active material particle is formed by, for example, the foregoing vapor phase process, etc. However, the negative electrode active material particle may be formed by a process other than the vapor phase process.

In the case where the negative electrode active material particle is formed by a deposition process such as a vapor phase process, the negative electrode active material particle may have a single-layered structure formed through a single deposition step, or may have a multilayered structure formed through plural deposition steps. However, in the case where the negative electrode active material particle is formed by a vapor deposition process accompanied with high heat at the time of deposition, it is preferable that the negative electrode active material particle has a multilayered structure. This is because when the deposition step of the negative electrode material is carried out in a divided manner of plural times (the negative electrode material is successively formed thin and deposited), the time when the negative electrode collector 22A is exposed at high temperatures becomes short, and a thermal damage is hardly given as compared with the case of carrying out the deposition step once.

For example, this negative electrode active material particle grows in a thickness direction of the negative electrode active material layer 22B from the surface of the negative electrode collector 22A and is connected to the negative electrode collector 22A in a root thereof. In that case, it is preferable that the negative electrode active material particle is formed by a vapor phase process and alloyed on at least a part of the interface with the negative electrode collector 22A as described previously. In detail, on the interface between the both, the constituent elements of the negative electrode collector 22A may be diffused into the negative electrode active material particle, the constituent elements of the negative electrode active material particle may be diffused into the negative electrode collector 22A, or the constituent elements of the both may be mutually diffused.

In particular, it is preferable that the negative electrode active material layer 22B has an oxide-containing film for coating the surface of the negative electrode active material particle (region coming into contact with the electrolytic solution) as the need arises. This is because the oxide-containing film functions as a protective film against the electrolytic solution, and even when charge and discharge are repeated, a decomposition reaction of the electrolytic solution is suppressed, and therefore, the cycle characteristic is enhanced. This oxide-containing film may coat a part or the whole of the surface of the negative electrode active material particle.

For example, this oxide-containing film contains an oxide of at least one member selected from the group consisting of silicon, germanium and tin. Of these, it is preferable that the oxide-containing film contains an oxide of silicon. This is because not only it is easily coated over the entire surface of the negative electrode active material particle, but an excellent protective action is obtained. As a matter of course, the oxide-containing film may contain an oxide other than those described above. This oxide-containing film is formed by, for example, a vapor phase process or a liquid phase process. Of these, a liquid phase process such as a liquid phase deposition process, a sol-gel process, a coating process and a dip coating process is preferable, with a liquid phase deposition processing being more preferable. This is because the surface of the negative electrode active material particle can be easily coated over a wide range thereof.

Also, it is preferable that the negative electrode active material layer 22B has a metal material which is not alloyed with an electrode reactant in a gap between particles of the negative electrode active material particle or in a gap within the particle as the need arises. This is because not only the plural negative electrode active material particles are bound to each other via the metal material, but in view of the fact that the metal material exists in the foregoing gap, expansion and shrinkage of the negative electrode active material layer 22B are suppressed, whereby the cycle characteristic is enhanced.

For example, this metal material contains, as a constituent element, a metal element which is not alloyed with lithium. Examples of such a metal element include at least one member selected from the group consisting of iron, cobalt, nickel, zinc and copper. Of these, cobalt is preferable. This is because not only the metal material is easy to come into the foregoing gap, but an excellent binding action is obtained. As a matter of course, the metal element may contain a metal element other than those described above. However, the “metal material” as referred to herein is a broad concept including not only simple substances but alloys and metal compounds. This metal material is formed by, for example, a vapor phase process or a liquid phase process. Of these, a liquid phase process such as an electrolytic plating process and a non-electrolytic plating process is preferable, and an electrolytic plating process is more preferable. This is because not only the metal material is easy to come into the foregoing gap, but the formation time may be short.

The negative electrode active material layer 22B may contain either one or both of the foregoing oxide-containing film and metal material. However, in order to more enhance the cycle characteristic, it is preferable that the negative electrode active material layer 22B contains the both of them.

The separator 23 partitions the positive electrode 21 and the negative electrode 22 from each other and allows a lithium ion to pass therethrough while preventing a short circuit of the current to be caused due to the contact of the both electrodes. This separator 23 is, for example, configured of a porous film made of a synthetic resin such as polytetrafluoroethylene, polypropylene and polyethylene, a porous film made of a ceramic, or the like and may be a laminate of two or more kinds of these porous films.

An electrolytic solution which is a liquid electrolyte is impregnated in this separator 23. This electrolytic solution contains a solvent and an electrolyte salt dissolved therein.

For example, the solvent contains one or two or more kinds of non-aqueous solvents such as organic solvents. Examples of such a non-aqueous solvent include carbonate based solvents such as ethylene carbonate, propylene carbonate, butylene carbonate, dimethyl carbonate, diethyl carbonate, ethylmethyl carbonate and methylpropyl carbonate. This is because excellent capacity characteristic, cycle characteristic and storage characteristic are obtained. Of these, a mixture of a high-viscosity solvent (for example, ethylene carbonate, propylene carbonate, etc.) and a low-viscosity solvent (for example, dimethyl carbonate, ethylmethyl carbonate, diethyl carbonate, etc.) is preferable. This is because dissociation properties of an electrolyte salt and mobility of an ion are enhanced, and therefore, a higher effect is obtained.

It is preferable that this solvent contains an unsaturated bond-containing cyclic carbonate represented by each of the following formulae (4) to (6). This is because the cycle characteristic is enhanced. These compounds may be used singly or in admixture of plural kinds thereof.

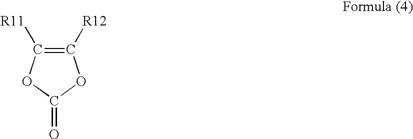

In the formula (4), R11 and R12 each represents a hydrogen group or an alkyl group.

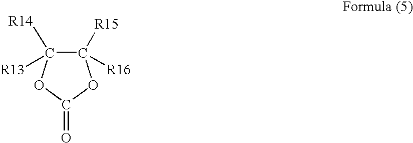

In the formula (5), R13 to R16 each represents a hydrogen group, an alkyl group, a vinyl group or an allyl group, provided that at least one of R13 to R16 is a vinyl group or an allyl group.

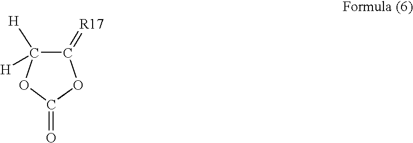

In the formula (6), R17 represents an alkylene group.

The unsaturated bond-containing cyclic carbonate represented by the formula (4) is a vinylene carbonate based compound. Examples of the vinylene carbonate based compound include vinylene carbonate (1,3-dioxol-2-one), methylvinylene carbonate (4-methyl-1,3-dioxol-2-one), ethylvinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one and 4-trifluoromethyl-1,3-dioxol-2-one. Of these, vinylene carbonate is preferable. This is because not only this compound is easily available, but a high effect is obtained.

The unsaturated bond-containing cyclic carbonate represented by the formula (5) is a vinylethylene carbonate based compound. Examples of the vinylethylene carbonate based compound include vinylethylene carbonate (4-vinyl-1,3-dioxolan-2-one), 4-methyl-4-vinyl-1,3-dioxolan-2-one, 4-ethyl-4-vinyl-1,3-dioxolan-2-one, 4-n-propyl-4-vinyl-1,3-dioxolan-2-one, 5-methyl-4-vinyl-1,3-dioxolane-2-one, 4,4-divinyl-1,3-dioxolan-2-one and 4,5-divinyl-1,3-dioxolan-2-one. Of these, vinylethylene carbonate is preferable. This is because not only this compound is easily available, but a high effect is obtained. As a matter of course, all of R13 to R16 may be a vinyl group or may be an allyl group, or a vinyl group and an allyl group may coexist.

The unsaturated bond-containing cyclic carbonate represented by the formula (6) is a methylene ethylene carbonate based compound. Examples of the methylene ethylene carbonate based compound include 4-methylene-1,3-dioxolan-2-one, 4,4-dimethyl-5-methylene-1,3-dioxolan-2-one and 4,4-diethyl-5-methylene-1,3-dioxolan-2-one. This methylene ethylene carbonate based compound may be a compound containing two methylene groups as well as a compound containing one methylene group (the compound represented by the formula (6)).

In addition to those represented by the formulae (4) to (6), the unsaturated bond-containing cyclic carbonate may be a benzene ring-containing carbonic catechol (catechol carbonate).

Also, it is preferable that the solvent contains at least one member of a chain carbonate containing a halogen as a constituent element, which is represented by the following formula (7), and a cyclic carbonate containing a halogen as a constituent element, which is represented by the following formula (8). This is because a stable protective film is formed on the surface of the negative electrode 22, and a decomposition reaction of an electrolytic solution is suppressed, and therefore, the cycle characteristic is enhanced.

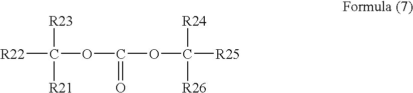

In the formula (7), R21 to R26 each represents a hydrogen group, a halogen group, an alkyl group or a halogenated alkyl group, provided that at least one of R21 to R26 is a halogen group or a halogenated alkyl group.

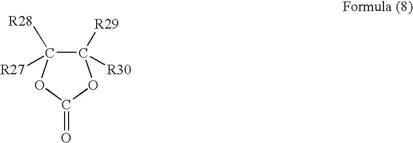

In the formula (8), R27 to R30 each independently represents a hydrogen group, a halogen group, an alkyl group or a halogenated alkyl group, provided that at least one of R27 to R30 is a halogen group or a halogenated alkyl group.

In the formula (7), R21 to R26 may be the same or different. The same is also applicable with respect to R27 to R30 in the formula (8). Though the kind of the halogen is not particularly limited, examples thereof include at least one member selected from the group consisting of fluorine, chlorine and bromine. Of these, fluorine is preferable. This is because a high effect is obtained. As a matter of course, other halogen may be applicable.

The number of the halogen is more preferably 2 than 1 and may be 3 or more. This is because the ability for forming a protective film is high, and a firmer and more stable protective film is formed, and therefore, a decomposition reaction of an electrolytic solution is more suppressed.

Examples of the chain carbonate containing a halogen, which is represented by the formula (7), include fluoromethylmethyl carbonate, bis(fluoromethyl) carbonate and difluoromethylmethyl carbonate. These compounds may be used singly or in admixture of plural kinds thereof.

Examples of the cyclic carbonate containing a halogen, which is represented by the formula (8), include a series of compounds represented by the following formulae. That is, examples thereof include compounds of a group of the formula (9) inclusive of the following (1) 4-fluoro-1,3-dioxolan-2-one, (2) 4-chloro-1,3-dioxolan-2-one, (3) 4,5-difluoro-1,3-dioxolan-2-one, (4) tetrafluoro-1,3-dioxolan-2-one, (5) 4-fluoro-5-chloro-1,3-dioxolan-2-one, (6) 4,5-dichloro-1,3-dioxolan-2-one, (7) tetrachloro-1,3-dioxolan-2-one, (8) 4,5-bistrifluoromethyl-1,3-dioxolan-2-one, (9) 4-trifluoromethyl-1,3-dioxolan-2-one, (10) 4,5-difluoro-4,5-dimethyl-1,3-dioxolan-2-one, (11) 4-methyl-5,5-difluoro-1,3-dioxolan-2-one and (12) 4-ethyl-5,5-difluoro-1,3-dioxolan-2-one. Also, examples include compounds of a group of the formula (10) inclusive of the following (1) 4-trifluoromethyl-5-fluoro-1,3-dioxolan-2-one, (2) 4-trifluoromethyl-5-methyl-1,3-dioxolan-2-one, (3) 4-fluoro-4,5-dimethyl-1,3-dioxolan-2-one, (4) 4,4-difluoro-5-(1,1-difluoroethyl)-1,3-dioxolan-2-one, (5) 4,5-dichloro-4,5-dimethyl-1,3-dioxolan-2-one, (6) 4-ethyl-5-fluoro-1,3-dioxolan-2-one, (7) 4-ethyl-4,5-difluoro-1,3-dioxolan-2-one, (8) 4-ethyl-4,5,5-trifluoro-1,3-dioxolan-2-one and (9) 4-fluoro-4-methyl-1,3-dioxolan-2-one. These compounds may be used singly or in admixture of plural kinds thereof.

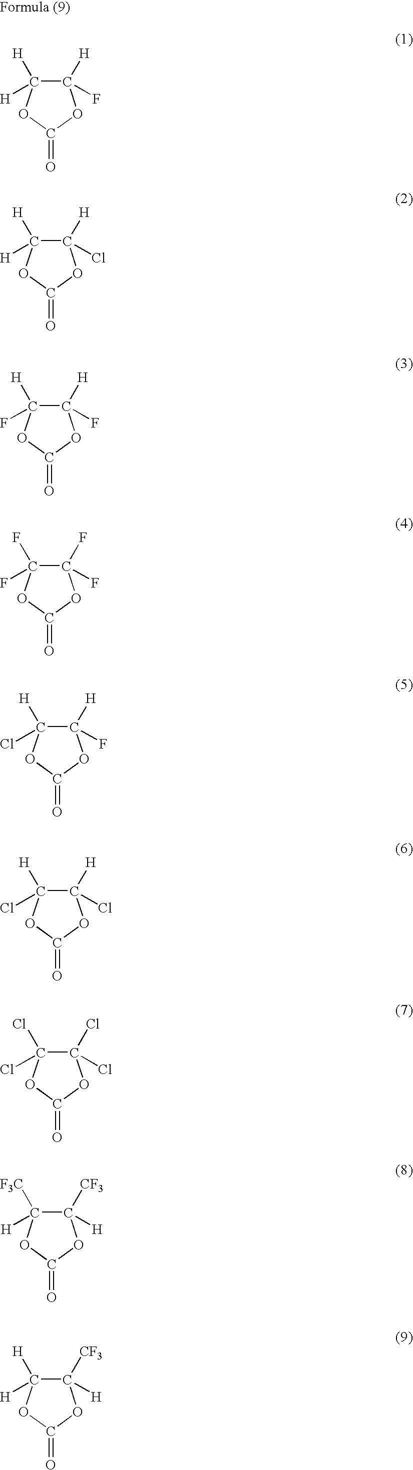

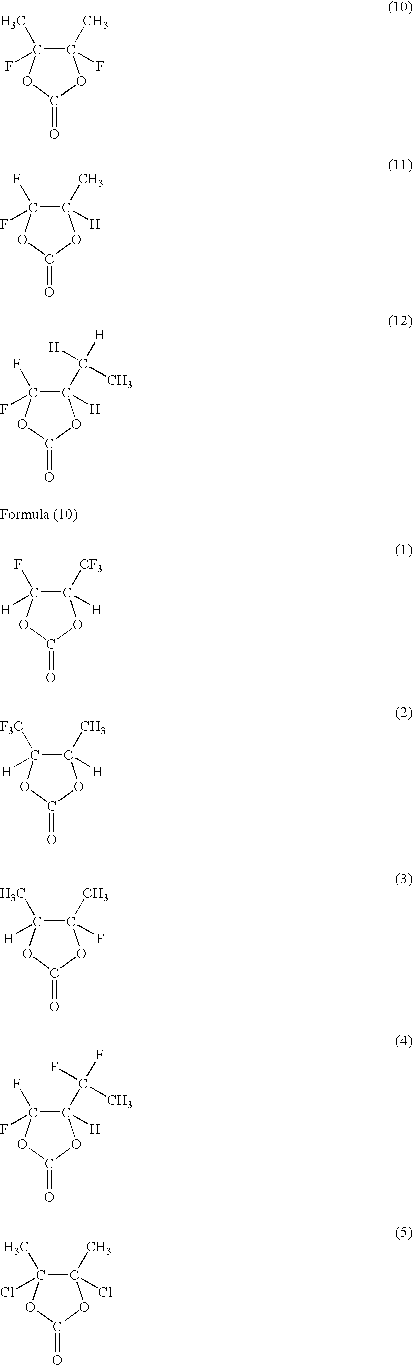

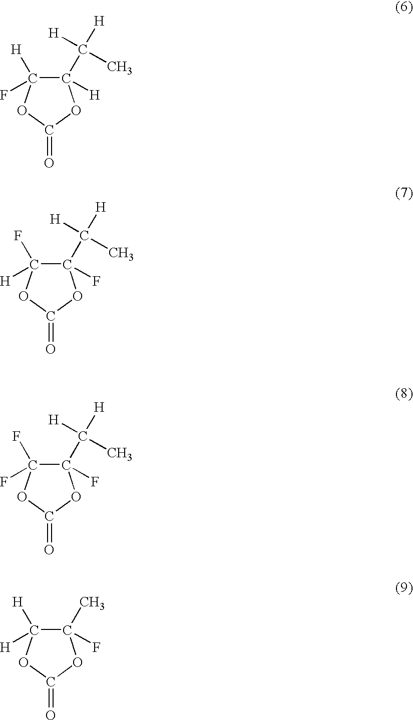

Of these, 4-fluoro-1,3-dioxolan-2-one and 4,5-difluoro-1,3-dioxolan-2-one are preferable; and 4,5-difluoro-1,3-dioxolan-2-one is more preferable. In particular, when 4,5-difluoro-1,3-dioxolan-2-one is concerned, a trans isomer is more preferable than a cis isomer. This is because not only this compound is easily available, but a high effect is obtained.

The electrolyte salt contains, for example, one or two or more kinds of light metal salts such as lithium salts. Examples of the lithium salt include lithium hexafluorophosphate, lithium tetrafluoroborate, lithium perchlorate and lithium hexafluoroarsenate. This is because excellent capacity characteristic, cycle characteristic and storage characteristic are obtained. Of these, lithium hexafluorophosphate is preferable. This is because an internal resistance is lowered, and therefore, a higher effect is obtained.

It is preferable that this electrolyte salt contains at least one member selected from the group consisting of compounds represented by the following formulae (11) to (13). This is because when such a compound is used together with the foregoing lithium hexafluorophosphate or the like, a higher effect is obtained. In the formula (11), R33s may be the same or different; and the same is also applicable with respect to R41 to R43 in the formula (12) and R51 and R52 in the formula (13).

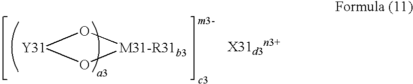

In the formula (11), X31 represents an element belonging to the Group 1 or the Group 2 of the long form of the periodic table or aluminum. M31 represents a transition metal or an element belonging to the Group 13, the Group 14 or the Group 15 of the long form of the periodic table. R31 represents a halogen group. Y31 represents —OC—R32-CO—, —OC—C(R33)₂— or —OC—CO—. R32 represents an alkylene group, a halogenated alkylene group, an arylene group or a halogenated arylene group. R33 represents an alkyl group, a halogenated alkyl group, an aryl group or a halogenated aryl group. a3 represents an integer of from 1 to 4; b3 represents an integer of 0, 2 or 4; and c3, d3, m3 and n3 each represents an integer of from 1 to 3.

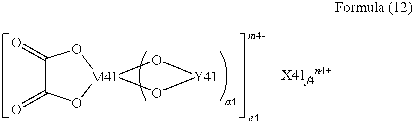

In the formula (12), X41 represents an element belonging to the Group 1 or the Group 2 of the long form of the periodic table. M41 represents a transition metal or an element belonging to the Group 13, the Group 14 or the Group 15 of the long form of the periodic table. Y41 represents —OC—(C(R41)₂)_{b4}—CO—, —(R43)₂C—(C(R42)₂)_{c4}—CO—, —(R43)₂C—(C(R42)₂)_{c4}—C(R43)₂—, —(R43)₂)_{c4}—SO₂—, —O₂S—(C(R42)₂)_{d4}—SO₂— or —OC—(C(R42)₂)_{d4}—SO₂—. R41 and R43 each represents a hydrogen group, an alkyl group, a halogen group or a halogenated alkyl group, and at least one of R41 and R43 is a halogen atom or a halogenated alkyl group. R42 represents a hydrogen group, an alkyl group, a halogen group or a halogenated alkyl group. a4, e4 and n4 each represents an integer of 1 or 2; b4 and d4 each represents an integer of from 1 to 4; c4 represents an integer of from 0 to 4; and f4 and m4 each represents an integer of from 1 to 3.

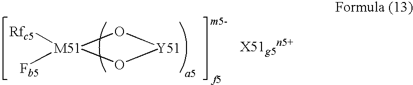

In the formula (13), X51 represents an element belonging to the Group 1 or the Group 2 of the long form of the periodic table. M51 represents a transition metal or an element belonging to the Group 13, the Group 14 or the Group 15 of the long form of the periodic table. Rf represents a fluorinated alkyl group or a fluorinated aryl group each having from 1 to 10 carbon atoms. Y51 represents —OC—(C(R51)₂)_{d5}—CO—, —(R52)₂C—(C(R51)₂)_{d5}—CO—, —(R52)₂C—(C(R51)₂)_{d5}—C(R52)₂—, —(R52)₂C—(C(R51)₂)_{d5}—SO₂—, —O₂S—(C(R51)₂)_{d5}—SO₂— or —OC—(C(R51)₂)ₑ₅—SO₂—. R51 represents a hydrogen group, an alkyl group, a halogen group or a halogenated alkyl group. R52 represents a hydrogen group, an alkyl group, a halogen group or a halogenated alkyl group, and at least one of R52 is a halogen group or a halogenated alkyl group. a5, f5 and n5 each represents an integer of 1 or 2; b5, c5 and e5 each represents an integer of from 1 to 4; d5 represents an integer of from 0 to 4; and g5 and m5 each represents an integer of from 1 to 3.

The “long form of the periodic table” referred to herein is one expressed by a revised version of the nomenclature of inorganic chemistry advocated by IUPAC (International Union of Pure and Applied Chemistry). Specifically, examples of the element belonging to the Group 1 include hydrogen, lithium, sodium, potassium, rubidium, cesium and francium. Examples of the element belonging to the Group 2 include beryllium, magnesium, calcium, strontium, barium and radium. Examples of the element belonging to the Group 13 include boron, aluminum, gallium, indium and thallium. Examples of the element belonging to the Group 14 include carbon, silicon, germanium, tin and lead. Examples of the element belonging to the Group 15 include nitrogen, phosphorus, arsenic, antimony and bismuth.

Examples of the compound represented by the formula (11) include compounds represented by (1) to (6) of the following formula (14). Examples of the compound represented by the formula (12) include compounds represented by (1) to (8) of the following formula (15). Examples of the compound represented by the formula (13) include a compound represented by the following formula (16). Needless to say, it should be construed that the compound is not limited to the compounds represented by the formulae (14) to (16) so far as the compound has a structure represented by any of the formulae (11) to (13).

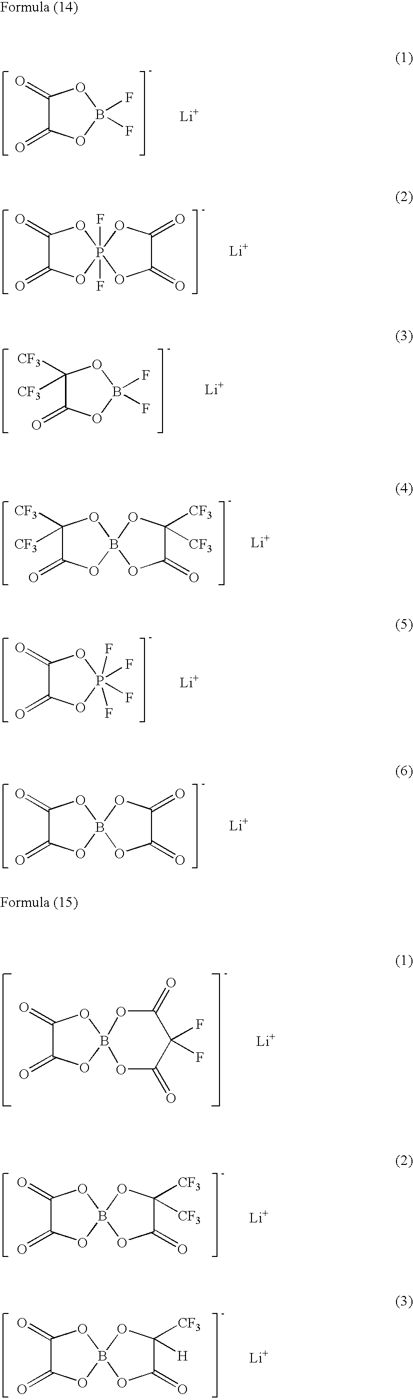

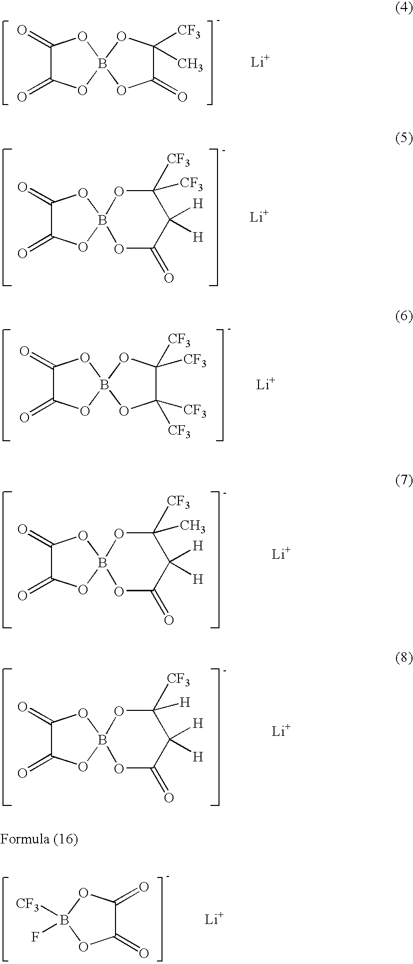

Also, the electrolyte salt may contain at least one member selected from the group consisting of compounds represented by the following formulae (17) to (19). This is because when such a compound is used together with the foregoing lithium hexafluorophosphate or the like, a higher effect is obtained. In the formula (17), m and n may be the same or different. The same is also applicable with respect to p, q and r in the formula (19).

LiN(CₘF₂ₘ₊₁SO₂)(CₙF₂ₙ₊₁SO₂) Formula (17)

In the formula (17), m and n each represents an integer of 1 or more.

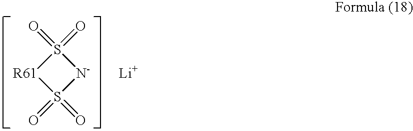

In the formula (18), R61 represents a linear or branched perfluoroalkylene group having 2 or more and not more than 4 carbon atoms.

LiC(CₚF₂ₚ₊₁SO₂)(C_{q}F_{2q+1}SO₂)(CᵣF₂ᵣ₊₁SO₂) Formula (19)

In the formula (19), p, q and r each represents an integer of 1 or more.

Examples of the chain compound represented by the formula (17) include bis(trifluoromethanesulfonyl)imide lithium (LiN(CF₃SO₂)₂), bis(pentafluoroethanesulfonyl)imide lithium (LiN(C₂F₅ SO₂)₂), (trifluoromethanesulfonyl)(pentafluoroethanesulfonyl)imide lithium (LiN(CF₃SO₂)(C₂F₅SO₂)), (trifluoromethanesulfonyl)(heptafluoropropanesulfonyl)imide lithium (LNCF₃SO₂)(C₃F₇SO₂)) and (trifluoromethanesulfonyl)(nonafluorobutanesulfonyl)imide lithium (LiN(CF₃SO₂)(C₄F₉SO₂)). These compounds may be used singly or in admixture of plural kinds thereof.

Examples of the cyclic compound represented by the formula (18) include a series of compounds represented by the following formula (20). That is, examples of the compound represented by the formula (20) include the following (1) 1,2-perfluoroethanedisulfonylimide lithium, (2) 1,3-perfluoropropanedisulfonylimide lithium, (3) 1,3-perfluorobutanedisulfonylimide lithium and (4) 1,4-perfluorobutanedisulfonylimide lithium. These compounds may be used singly or in admixture of plural kinds thereof. Of these, 1,2-perfluoroethanedisulfonylimide lithium is preferable. This is because a high effect is obtained.

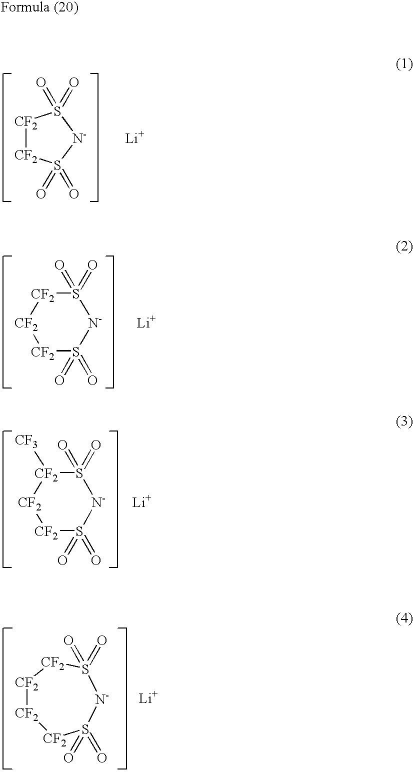

Examples of the chain compound represented by the formula (19) include lithium tris(trifluoromethanesulfonyl)methide (LiC(CF₃SO₂)₃).

A content of the electrolyte salt is preferably 0.3 moles/kg or more and not more than 3.0 moles/kg relative to the solvent. This is because when the content of the electrolyte salt falls outside the foregoing range, there is a possibility that the ionic conductivity is extremely lowered.

The electrolytic solution may contain various additives together with the solvent and the electrolyte salt. This is because the chemical stability of the electrolytic solution is more enhanced.

Examples of the additive include sultones (cyclic sulfonic acid esters). Examples of the sultone include propane sultone and propene sultone. Of these, propane sultone is preferable. These compounds may be used singly or in admixture of plural kinds thereof. A content of the sultone in the electrolytic solution is, for example, 0.5% by mass or more and not more than 5% by mass.

Also, examples of the additive include acid anhydrides. Examples of the acid anhydride include carboxylic acid anhydrides (for example, succinic anhydride, glutaric anhydride, maleic anhydride, etc.); disulfonic acid anhydrides (for example, ethanedisulfonic anhydride, propanedisulfonic anhydride, etc.); and anhydrides of a carboxylic acid and a sulfonic acid (for example, sulfobenzoic anhydride, sulfopropionic anhydride, sulfobutyric anhydride, etc.). Of these, succinic anhydride and sulfobenzoic anhydride are preferable. These compounds may be used singly or in admixture of plural kinds thereof. A content of the acid anhydride in the electrolytic solution is, for example, 0.5% by mass or more and not more than 5% by mass.

This secondary battery is, for example, manufactured according to the following procedures.

The positive electrode 21 is first prepared. First of all, in the case of forming a film of the salt represented by the formula (1) on the surface, an aqueous solution of this compound is added to a positive electrode active material, and the mixture is dried while stirring, whereby a film of the salt represented by the formula (1) can be formed on the surface of the active material. This positive electrode active material is mixed with a binder and a conductive agent to form a positive electrode mixture, which is then dispersed in an organic solvent to form a positive electrode mixture slurry in a paste form. Subsequently, the positive electrode mixture slurry is uniformly coated on the both surfaces of the positive electrode collector 21A by a doctor blade, a bar coater or the like, followed by drying. Finally, the coating film is subjected to compression molding by a roll press or the like while heating, if desired, thereby forming the positive electrode active material layer 21B. In that case, the compression molding may be repeated plural times.

Also, an untreated active material is used and subjected to compression molding to form the positive electrode active material layer 21B, which is then dipped in and coated with an aqueous solution of the salt represented by the formula (1) and dried. There can be thus formed the positive electrode film 21C on the electrode.

Subsequently, the negative electrode 22 is prepared. First of all, the negative electrode collector 22A made of an electrolytic copper foil or the like is prepared, and a negative electrode material is then deposited on the both surfaces of the electrode collector 22A by a vapor phase process such as a vapor deposition process, thereby forming plural negative electrode active material particles. Subsequently, if desired, an oxide-containing film is formed by a liquid phase process such as a liquid phase deposition process, or a metal material is formed by a liquid phase process such as an electrolytic plating process, thereby forming the negative electrode active material layer 22B.

Subsequently, the positive electrode lead 25 is installed in the positive electrode collector 21A by means of welding, etc., and the negative electrode lead 26 is also installed in the negative electrode collector 22A by means of welding, etc. Thereafter, the positive electrode 21 and the negative electrode 22 are laminated via the separator 23 and then wound in a longitudinal direction to prepare the wound electrode body 20.

Assembling of a secondary battery is carried out in the following manner. First of all, a tip of the positive electrode lead 25 is welded to the safety valve mechanism 15; and a tip of the negative electrode lead 26 is also welded to the battery can 11. Subsequently, the wound electrode body 20 is housed in the inside of the battery can 11 while being interposed between a pair of the insulating plates 12 and 13. Subsequently, an electrolytic solution is injected into the inside of the battery can 11 and impregnated in the separator 23. Finally, the battery lid 14, the safety valve mechanism 15 and the temperature coefficient element 16 are fixed to the open end of the battery can 11 via the gasket 17 by caulking. There is thus completed the secondary battery shown in FIGS. 1 and 2.

In this secondary battery, when charge is carried out, for example, a lithium ion is deintercalated from the positive electrode 21 and intercalated into the negative electrode 22 via the electrolytic solution impregnated in the separator 23. On the other hand, when discharge is carried out, for example, a lithium ion is deintercalated from the negative electrode 22 and intercalated into the positive electrode 21 via the electrolytic solution impregnated in the separator 23.

According to this secondary battery of a cylinder type, since the positive electrode has the same configuration as the foregoing positive electrode, the chemical stability of the positive electrode is enhanced. According to this, since a lithium ion is easily intercalated and deintercalated in the positive electrode, the battery resistance can be suppressed. In that case, the film is formed by using a solution containing the salt represented by the formula (1), and specifically, a simple treatment such as a dipping treatment and a coating treatment is adopted, and therefore, the positive electrode film 21C with good properties can be formed simply.

(Second Secondary Battery)

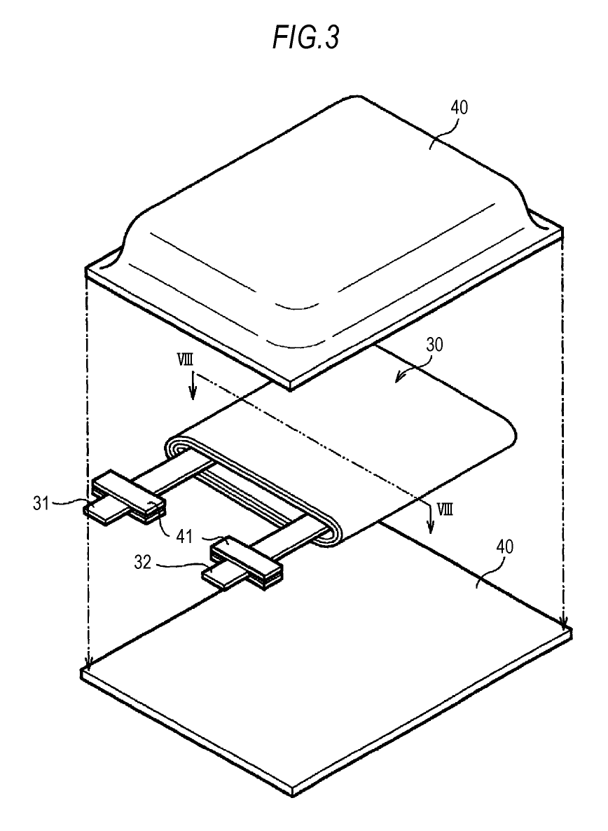

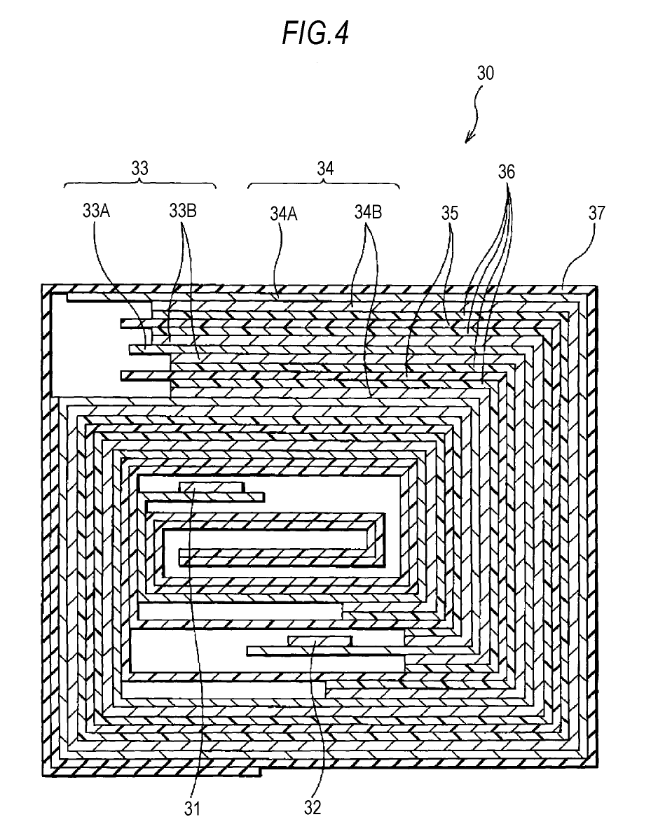

FIG. 3 shows an exploded perspective configuration of a second secondary battery, and FIG. 4 shows enlargedly a section along a V-VIII line of a wound electrode body 30 shown in FIG. 3.

This secondary battery is, for example, a lithium ion secondary battery similar to the foregoing first secondary battery and is chiefly one in which a wound electrode body 30 having a positive electrode lead 31 and a negative electrode lead 32 installed therein is housed in the inside of an exterior member 40 in a film form. The battery structure using this exterior member 40 in a film form is called a laminated film type.

The positive electrode lead 31 and the negative electrode lead 32 are each led out in, for example, the same direction from the inside toward the outside of the exterior member 40. The positive electrode lead 31 is made of a metal material, for example, aluminum, etc., and the negative electrode lead 32 is made of a metal material, for example, copper, nickel, stainless steel, etc. Such a metal material is formed in a thin plate state or network state.

The exterior member 40 is made of, for example, an aluminum laminated film obtained by sticking a nylon film, an aluminum foil and a polyethylene film in this order. For example, this exterior member 40 has a structure in which the respective outer edges of the two rectangular aluminum laminated films are allowed to adhere to each other by means of fusion or with an adhesive such that the polyethylene film is disposed opposing to the wound electrode body 30.

A contact film 41 is inserted between the exterior member 40 and each of the positive electrode lead 31 and the negative electrode lead 32 for the purpose of preventing invasion of the outside air. This contact film 41 is made of a material having adhesion to the positive electrode lead 31 and the negative electrode lead 32. Examples of such a material include polyolefin resins such as polyethylene, polypropylene, modified polyethylene and modified polypropylene.

The exterior member 40 may be made of a laminated film having other laminated structure, a polymer film such as polypropylene or a metal film in place of the foregoing aluminum laminated film.

The wound electrode body 30 is one prepared by laminating a positive electrode 33 and a negative electrode 34 via a separator 35 and an electrolyte 36 and winding the laminate, and an outermost peripheral part thereof is protected by a protective tape 37.

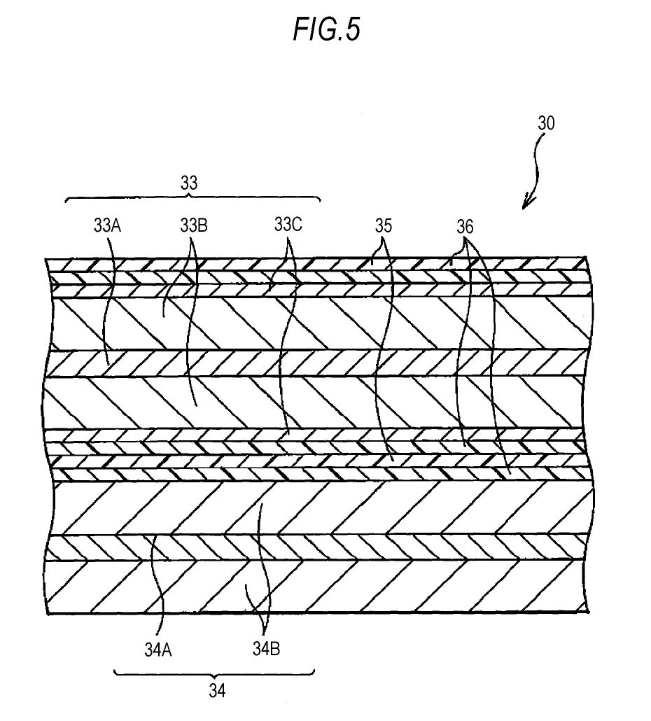

FIG. 5 shows enlargedly a part of the wound electrode body 30 shown in FIG. 4. The positive electrode 33 is, for example, one in which a positive electrode active material layer 33B and a film 33C are provided on the both surfaces of a positive electrode collector 33A having a pair of surfaces. The negative electrode 34 is, for example, one in which a negative electrode active material layer 34B is provided on the both surfaces of a negative electrode collector 34A having a pair of surfaces. The configuration of each of the positive electrode collector 33A, the positive electrode active material layer 33B, the positive electrode film 33C, the negative electrode collector 34A, the negative electrode active material layer 34B and the separator 35 is the same as the configuration of each of the positive electrode collector 21A, the positive electrode active material layer 21B, the positive electrode film 21C, the negative electrode collector 22A, the negative electrode active material layer 22B and the separator 23 in the foregoing first secondary battery.

The electrolyte 36 is an electrolyte in a so-called gel form, which contains an electrolytic solution and a polymer compound for holding this electrolytic solution therein. The electrolyte in a gel form is preferable because not only high ionic conductivity (for example, 1 mS/cm or more at room temperature) is obtained, but the liquid leakage is prevented.

Examples of the polymer compound include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubbers, nitrile-butadiene rubbers, polystyrene and polycarbonates. These compounds may be used singly or in admixture of plural kinds thereof. Of these, polyacrylonitrile, polyvinylidene fluoride, polyhexafluoropropylene and polyethylene oxide are preferable. This is because these compounds are electrochemically stable.

A composition of the electrolytic solution is the same as the composition of the electrolytic solution in the first secondary battery. However, in that case, the term “solvent” has a broad concept including not only a liquid solvent but a solvent with ionic conductivity such that it is able to dissociate the electrolyte salt. Accordingly, in the case of using a polymer compound with ionic conductivity, the subject polymer compound is also included in the solvent.

In place of the electrolyte 36 in a gel form, in which an electrolytic solution is held in a polymer compound, the electrolytic solution may be used as it is. In that case, the electrolytic solution is impregnated in the separator 35.

The secondary battery provided with the electrolyte 36 in a gel form is manufactured by the following three kinds of methods.

In a first manufacturing method, first of all, for example, not only the positive electrode active material layer 33B and the positive electrode film 33C are is formed on the both surfaces of the positive electrode collector 33A to form the positive electrode 33, but the negative electrode active material layer 34B is formed on the both surfaces of the negative electrode collector 34A according to the same procedures as the preparation procedures of the positive electrode 21 and the negative electrode 22 in the foregoing first secondary battery. Subsequently, a precursor solution containing an electrolytic solution, a polymer compound and a solvent is prepared and coated on each of the positive electrode 33 and the negative electrode 34, and the solvent is then vaporized off to form the electrolyte 36 in a gel form. Subsequently, the positive electrode lead 31 is installed in the positive electrode collector 33A, and the negative electrode lead 32 is also installed in the negative electrode collector 34A. Subsequently, the positive electrode 33 and the negative electrode 34 each having the electrolyte 36 formed thereon are laminated via the separator 35, the laminate is then wound in a longitudinal direction thereof, and the protective tape 37 is allowed to adhere to the outermost peripheral part to form the wound electrode body 30. Finally, for example, the wound electrode body 30 is interposed between the two exterior members 40 in a film form, and the outer edges of the exterior members 40 are allowed to adhere to each other by means of heat fusion, etc., thereby sealing the wound electrode body 30. On that occasion, the contact film 41 is inserted between each of the positive electrode lead 31 and the negative electrode lead 32 and the exterior member 40. According to this, the secondary battery shown in FIGS. 3 to 5 is completed.

In a second manufacturing method, first of all, the positive electrode lead 31 is installed in the positive electrode 33, and the negative electrode lead 32 is also installed in the negative electrode 34; the positive electrode 33 and the negative electrode 34 are then laminated via the separator 35 and wound; and the protective tape 37 is allowed to adhere to the outermost peripheral part, thereby forming a wound body serving as a precursor of the wound electrode body 30. Subsequently, the wound body is interposed between the two exterior members 40, and the outer edges exclusive of one side are allowed to adhere to each other by means of heat fusion, etc. and then housed in the inside of the exterior member 40 in a bag form. Subsequently, a composition for electrolyte containing an electrolytic solution, a monomer as a raw material of the polymer compound, a polymerization initiator and optionally other materials such as a polymerization inhibitor is prepared and injected into the inside of the exterior member 40 in bag form. Thereafter, an opening of the exterior member 40 is hermetically sealed by means of heat fusion, etc. Finally, the monomer is heat polymerized to form a polymer compound, thereby forming the electrolyte layer 36 in a gel form. There is thus completed the secondary battery.

In a third manufacturing method, first of all, a wound body is formed in the same manner as in the foregoing second manufacturing method, except for using the separator 35 having a polymer compound coated on the both surfaces thereof, and then housed in the inside of the exterior member 40 in a bag form. Examples of the polymer compound which is coated on this separator 35 include polymers composed of, as a component, vinylidene fluoride, namely a homopolymer, a copolymer or a multi-component copolymer. Specific examples thereof include polyvinylidene fluoride; a two-component based copolymer composed of, as components, vinylidene fluoride and hexafluoropropylene; and a three-component based copolymer composed of, as components, vinylidene fluoride, hexafluoropropylene and chlorotrifluoroethylene. The polymer compound may contain one or two or more kinds of other polymer compounds together with the foregoing polymer composed of, as a component, vinylidene fluoride. Subsequently, an electrolytic solution is prepared and injected into the inside of the exterior member 40, and an opening of the exterior member 40 is then hermetically sealed by means of heat fusion, etc. Finally, the separator 35 is brought into intimate contact with the positive electrode 33 and the negative electrode 34 via the polymer compound upon heating while adding a weight to the exterior member 40. According to this, the electrolytic solution is impregnated in the polymer compound, and the polymer compound is gelled to form the electrolyte 36. There is this completed the secondary battery.

In this third manufacturing method, swelling of the secondary battery is suppressed as compared with the first manufacturing method. Also, in the third manufacturing method, the monomer as a raw material of the polymer compound, the solvent and the like do not substantially remain in the electrolyte 36 as compared with the second manufacturing method, and the forming step of a polymer compound is controlled well. Accordingly, sufficient adhesion between each of the positive electrode 33 and the negative electrode 34 and each of the separator 35 and the electrolyte 36 is obtained.

According to this secondary battery of a laminated film type, since the positive electrode has the same configuration as in the foregoing positive electrode, the cycle characteristic can be enhanced. Other effects regarding this secondary battery are the same as those in the first secondary battery.

### EXAMPLES

Working examples are described in detail.

### Example 1-1

One part by mass of the following Compound A (the salt represented by the formula (1)) was weighed relative to 100 parts by mass of a lithium cobalt complex oxide (LiCO_{0.98}Al_{0.01}Mg_{0.01}O₂) having an average particle size of 13 μm (measured by a laser scattering process), and the mixture was stirred in 100 mL of pure water for 5 minutes. After stirring, the water was removed by an evaporator, followed by drying in an oven at 120° C. for 12 hours. There was thus obtained a positive electrode active material having lithium cobaltate coated with Compound A.

By using the thus obtained positive electrode material, a laminated type battery was prepared in the following manner and evaluated for cycle characteristic and cell thickness at the time of high-temperature storage.

91 parts by mass of the lithium cobalt complex oxide, 6 parts by mass of graphite as a conductive agent and 3 parts by mass of polyvinylidene fluoride (PVdF) as a binder were mixed to form a positive electrode mixture, which was then dispersed in N-methyl-2-pyrrolidone to form a positive electrode mixture slurry in a paste form. Subsequently, the positive electrode mixture slurry was uniformly coated on the both surfaces of the positive electrode collector 33A made of a strip-shaped aluminum foil (thickness: 12 μm) by a bar coater, dried and then subjected to compression molding by a roll press, thereby forming the positive electrode active material layer 33B.

A negative electrode was prepared in the following manner. 90% by mass of a graphite powder and 10% by mass of PVdF were mixed to prepare a negative electrode mixture. This negative electrode mixture was dispersed in N-methyl-2-pyrrolidone to prepare a negative electrode mixture slurry, and the negative electrode mixture slurry was uniformly coated on the both surfaces of a negative electrode collector made of a strip-shaped copper foil, followed by press molding by heating to form a negative electrode active material layer.

A separator was prepared in the following manner. First all, N-methyl-2-pyrrolidone was added to a polyvinylidene fluoride resin (average molecular weight: 150,000) in a mass ratio of 10/90, and the mixture was thoroughly dissolved to prepare a 10% solution of PVdF in N-methyl-2-pyrrolidone.

Subsequently, the prepared slurry was coated on a microporous film as a mixture of polyethylene (PE) and polypropylene (PP) having a thickness of 7 μm as a substrate layer by a table coater, subsequently subjected to phase separation by a water bath and then dried by hot air, thereby obtaining a microporous film having a PVdF microporous layer and having a thickness of 4 μm.

Subsequently, the separator, the positive electrode and the negative electrode were laminated in the order of the negative electrode, the separator, the positive electrode and the separator and then wound several times, thereby preparing a generating device. This generating device and an electrolytic solution were put in a moistureproofing aluminum laminated film having a thickness of 180 μm and then subjected to vacuum sealing and thermo-compression-bonding, thereby preparing a flat plate type laminated battery having a dimension of approximately 34 mm×50 mm×3.8 mm.

As the electrolytic solution, LiPF₆ was dissolved in a concentration of 1 mole/dm³ in a mixed solution of ethylene carbonate (EC) and diethyl carbonate (DEC) in a volume ratio of 1/1, thereby preparing a non-aqueous electrolytic solution.

### Examples 1-2 to 1-7

Non-aqueous electrolytic solution secondary batteries were prepared in the same manner as in Example 1-1, except that an electrolytic solution additive (FEC: solvent) as shown in Table 1 was added in an amount of 0.5% (on a mass basis) relative to the electrolytic solution of Example 1-1.

### Examples 1-8 to 1-10

Non-aqueous electrolytic solution secondary batteries were prepared in the same manner as in Example 1-1, except that the salt represented by the formula (1) was changed to the following Compound B, Compound C and Compound D, respectively.

### Comparative Example 1-1

A non-aqueous electrolytic solution secondary battery was prepared in the same manner as in Example 1-1, except that the salt represented by the formula (1) was not used.

Each of the thus prepared non-aqueous electrolytic solution secondary batteries was evaluated for discharge capacity retention rate and swelling amount after 12 hours. The kind of the metal salt to be incorporated in the positive electrode is shown in the “positive electrode” column in Table 1, and the evaluation results are also shown in Table 1.

(1) Discharge Capacity Retention Rate:

Charge and discharge with two cycles were carried out in an atmosphere at 23° C., thereby measuring the discharge capacity; subsequently, charge and discharge were carried out in the same atmosphere until the total sum of cycle number reached 100 cycles, thereby measuring the discharge capacity; and thereafter, a discharge capacity retention rate (%)={(discharge capacity at the 100th cycle)/(discharge capacity at the 2nd cycle)}×100 was calculated. On that occasion, with respect to the charge and discharge condition with one cycle, charge was carried out at a constant current density of 800 mA until the battery voltage reached 4.2 V; charge was further carried out at a constant voltage of 4.2 V until the current density reached 40 mA; and thereafter, discharge was carried out at a constant current density of 800 mA until the battery voltage reached 3 V.

(2) Swelling Amount after 12 Hours:

After carrying out charge under a condition at a circumferential temperature of 45° C., a charge voltage of 4.20 V and a charge current of 800 mA for a charge time of 2.5 hours, discharge was carried out at a discharge current of 400 mA and a final voltage of 3.0 V. The cell was charged under a condition at a charge voltage of 4.2 V and a charge current of 800 mA for a charge time of 2.5 hours and then stored at 85° C. for 12 hours. An amount of increase of a thickness of the cell before and after the storage was measured and designated as a swelling amount after 12 hours.

TABLE 1

| | |
|---|---|
| | Compound A |
| 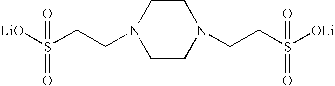 | |
| | Compound B |
| 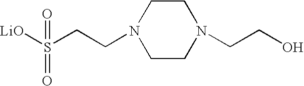 | |
| | Compound C |
| 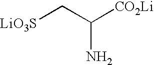 | |
| | Compound D |
| 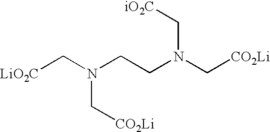 | |

| | | | | | Discharge | Swelling amount |
|---|---|---|---|---|---|---|
| | Positive | EC | DEC | Electrolytic solution | capacity | after 12 hours |
| | electrode | (vol) | (vol) | additive | retention rate | (mm) |
| Example 1-1 | Compound A | 50 | 50 | | 93 | 0.5 |
| Example 1-2 | Compound A | 50 | 50 | FEC | 94 | 0.4 |
| Example 1-3 | Compound A | 50 | 50 | Propene sultone | 93 | 0.3 |
| Example 1-4 | Compound A | 50 | 50 | Propanedisulfonic | 95 | 0.3 |
| | | | | anhydride | | |
| Example 1-5 | Compound A | 50 | 50 | Succinic anhydride | 94 | 0.4 |
| Example 1-6 | Compound A | 50 | 50 | LiBF₄ | 93 | 0.4 |
| Example 1-7 | Compound A | 50 | 50 | (1) of formula (14) | 94 | 0.4 |
| Example 1-8 | Compound B | 50 | 50 | | 93 | 0.4 |
| Example 1-9 | Compound C | 50 | 50 | | 93 | 0.5 |
| Example 1-10 | Compound D | 50 | 50 | | 93 | 0.7 |
| Comparative | Untreated | 50 | 50 | | 93 | 3.0 |
| Example 1-1 | | | | | | |

As shown in Table 1, it was noted that by incorporating each of Compound A, Compound B, Compound C and Compound D into the positive electrode, the increase of a thickness of the cell after the high-temperature storage can be suppressed.

### Example 2-1

The secondary battery of a laminated film type shown in FIGS. 3 to 5 was prepared according to the following procedures.

The positive electrode 33 was first prepared. First of all, lithium carbonate (Li₂CO₃) and cobalt carbonate (CoCO₃) were mixed in a molar ratio of 0.5/1 and then baked in air under a condition of 900° C.×5 hours to obtain a lithium cobalt complex oxide (LiCoO₂). Subsequently, 91 parts by mass of the lithium cobalt complex oxide as a positive electrode active material, 6 parts by mass of graphite as a conductive agent and 3 parts by mass of polyvinylidene fluoride as a binder were mixed to form a positive electrode mixture, which was then dispersed in N-methyl-2-pyrrolidone to prepare a positive electrode mixture slurry in a paste form. Subsequently, the positive electrode mixture slurry was uniformly coated on the both surfaces of the positive electrode collector 33A made of a strip-shaped aluminum foil (thickness: 12 μm) by a bar coater, dried and then subjected to compression molding by a roll press, thereby forming the positive electrode active material layer 33B. Subsequently, a 1.5% aqueous solution was prepared as a solution containing Compound A as the metal salt, and the positive electrode collector 33A having the positive electrode active material layer 33B provided thereon was dissolved in the solution for several seconds. Finally, the positive electrode collector 33A was lifted up from the solution and then dried in a vacuum atmosphere at 120° C., thereby forming the positive electrode film 33C on the positive electrode active material layer 33B.

Subsequently, the negative electrode 34 was prepared. First of all, the negative electrode collector 34A made of an electrolytic copper foil (thickness: 10 μm) was prepared, and silicon as a negative electrode active material was deposited in a thickness of 5 μm on the both surfaces of the negative electrode collector 34A by an electron beam vapor deposition process, thereby forming plural negative electrode active material particles. There was thus formed the negative electrode active material layer 34B. On that occasion, the charge capacity by the negative electrode active material was regulated at a level larger than the charge capacity of the positive electrode such that a lithium metal was not deposited on the negative electrode on the way of charge. In the case of providing this negative electrode active material layer 34B, by forming a negative electrode active material particle in a single deposition step, a single-layered structure was provided.

Subsequently, difluoroethylene carbonate (DFEC), fluoroethylene carbonate (FEC), ethylene carbonate (EC), propylene carbonate (PC) and diethyl carbonate (DEC) were mixed as a solvent, into which was then dissolved lithium hexafluorophosphate (LiPF₆) as an electrolyte salt, thereby preparing an electrolytic solution. On that occasion, a composition of the solvent (DFEC/FEC/EC/PC/DEC) was regulated at 5/10/10/25/50 in terms of a mass ratio, and a concentration of lithium hexafluorophosphate in the electrolytic solution was regulated at 1 mole/kg.

Finally, a secondary battery was assembled by using the electrolytic solution together with the positive electrode 33 and the negative electrode 34. First of all, the positive electrode lead 31 made of aluminum was welded to one end of the positive electrode collector 33A, and the negative electrode lead 32 made of nickel was also welded to one end of the negative electrode collector 34A. Subsequently, the positive electrode 33, the separator 35 made of a microporous polypropylene film (thickness: 25 μm) and the negative electrode 34 were laminated in this order, the laminate was wound in a longitudinal direction, and an end portion of winding was then fixed by the protective tape 37 made of an adhesive tape, thereby forming a wound body which is a precursor of the wound electrode body 30. Subsequently, the wound body was interposed within the exterior member 40 made of a three-layered laminated film having a nylon film (thickness: 30 μm), an aluminum foil (thickness: 40 μm) and a non-stretched polypropylene film (thickness: 30 μm) laminated therein (total thickness: 100 μm) from the outside, and thereafter, the outer edges exclusive of one side were heat fused to each other and then housed in the inside of the exterior member 40 in a bag form. Subsequently, an electrolytic solution was injected from an opening of the exterior member 40 and impregnated in the separator 35, thereby preparing the wound electrode body 30. Finally, the opening of the exterior member 40 was sealed by means of heat fusion in a vacuum atmosphere, thereby completing a secondary battery of a laminated film type.

### Examples 2-2 to 2-5

Non-aqueous electrolytic solution secondary batteries were prepared in the same manner as in Example 2-1, except that an electrolytic solution additive shown in Table 2 was added in an amount of 0.5% (on a mass basis) relative to the electrolytic solution of Example 2-1.

### Examples 2-6 to 2-8

Non-aqueous electrolytic solution secondary batteries were prepared in the same manner as in Example 2-1, except that the metal salt was changed to the foregoing Compound B, Compound C and Compound D, respectively.

### Comparative Example 2-1

A non-aqueous electrolytic solution secondary battery was prepared in the same manner as in Example 2-1, except that the metal salt was not used.

### Comparative Example 2-2

A non-aqueous electrolytic solution secondary battery was prepared in the same manner as in Comparative Example 2-1, except that tetrabutylamine was added in an amount of 1% (on a mass basis) relative to the electrolytic solution of Comparative Example 2-1

Each of the thus prepared non-aqueous electrolytic solution secondary batteries was evaluated for discharge capacity retention rate and swelling amount after 4 hours.

(1) Discharge Capacity Retention Rate:

Charge and discharge with two cycles were carried out in an atmosphere at 23° C., thereby measuring the discharge capacity; subsequently, charge and discharge were carried out in the same atmosphere until the total sum of cycle number reached 100 cycles, thereby measuring the discharge capacity; and thereafter, a discharge capacity retention rate (%)={(discharge capacity at the 100th cycle)/(discharge capacity at the 2nd cycle)}×100 was calculated. On that occasion, with respect to the charge and discharge condition with one cycle, charge was carried out at a constant current density of 1 mA/cm² until the battery voltage reached 4.2 V; charge was further carried out at a constant voltage of 4.2 V until the current density reached 0.02 mA/cm²; and thereafter, discharge was carried out at a constant current density of 1 mA/cm² until the battery voltage reached 2.5 V.

(2) Swelling Amount after 4 Hours:

After carrying out charge and discharge with two cycles in an atmosphere at 23° C., charge was again carried out, and the resulting thickness was measured. Subsequently, the secondary battery was stored in a charged state in a thermostat at 90° C. for 4 hours and then measured for its thickness. Thereafter, a swelling (mm)={(thickness after the storage)−(thickness before the storage)} was calculated. On that occasion, with respect to the charge and discharge condition with one cycle, charge was carried out at a constant current of 0.2 C until the battery voltage reached 4.2 V; and discharge was carried out at a constant current of 0.2 C until the battery voltage reached 2.5 V. The term “0.2 C” means a current value at which a theoretical capacity is completely discharged.

TABLE 2

| | | | Discharge | Swelling amount |
|---|---|---|---|---|
| | Positive | Electrolytic solution | capacity | after 4 hours |
| | electrode | additive | retention rate | (mm) |
| Example 2-1 | Compound A | | 92 | 0.98 |
| Example 2-2 | Compound A | Propene sultone | 92 | 0.83 |
| Example 2-3 | Compound A | Propane-disulfonic | 94 | 0.85 |
| | | anhydride | | |
| Example 2-4 | Compound A | Succinic anhydride | 93 | 0.88 |
| Example 2-5 | Compound A | LiBF₄ | 92 | 0.87 |
| Example 2-6 | Compound B | | 93 | 0.95 |
| Example 2-7 | Compound C | | 92 | 1.07 |
| Example 2-8 | Compound D | | 92 | 1.21 |
| Comparative | Untreated | | 92 | 1.80 |
| Example 2-1 | | | | |
| Comparative | Untreated | Added 1% | 87 | 3.10 |
| Example 2-2 | | tetrabutylamine | | |

As shown in Table 2, it was noted that by incorporating each of Compound A, Compound B, Compound C and Compound D into the positive electrode, the increase of a thickness of the cell after the high-temperature storage can be suppressed while keeping the discharge capacity retention rate. It is also noted that when only the amine is added to the electrolytic solution, not only the cycle characteristic is lowered, but the gas generation amount is high.

### Examples 3-1 to 3-8 and Comparative Examples 3-1 to 3-2

Non-aqueous electrolytic solution secondary batteries were prepared in the same procedures as in Examples 2-1 to 2-8 and Comparative Examples 2-1 to 2-2, except that the negative electrode active material layer 52B was provided by a coating process using an SnCoC-containing material as described later as a negative electrode active material in place of the silicon and that the composition of the solvent in the electrolytic solution was changed as described later, and then evaluated in the same manner. Details are as follows.

In the case of preparing the negative electrode active material, first of all, a tin powder and a cobalt powder were alloyed to form a tin cobalt alloy powder, to which was then added a carbon powder, followed by dry mixing. Subsequently, 20 g of the mixture and about 400 g of a steel ball having a diameter of 9 mm were set in a reactor of a planetary ball mill. Subsequently, the reactor was purged with an argon (Ar) atmosphere, and an operation of 10 minutes at a rotation speed of 250 rpm and a pause of 10 minutes were repeated until the total sum of the operation time reached 50 hours. Finally, the reactor was cooled to room temperature, and thereafter, a synthesized negative electrode active material powder was taken out and passed through a screen of 280 mesh to remove a coarse powder. Analysis of a composition of the obtained SnCoC-containing material revealed that a content of tin was 48% by mass; a content of cobalt was 23% by mass; a content of carbon was 20% by mass; and a proportion of cobalt relative to the total sum of tin and cobalt (Co/(Sn+Co)) was 32% by mass. In the case of analyzing the composition of the SnCoC-containing material, the content of carbon was measured using a carbon/sulfur analyzer; and the content of each of tin and cobalt was measured by means of ICP (inductively coupled plasma) emission spectrometry. Also, as a result of X-ray diffraction analysis of the obtained SnCoC-containing material, a diffraction peak having a wide half width value of 1.0° or more in terms of a diffraction angle 2θ was observed in the range of from 20° to 50° in terms of a diffraction angle 2θ. Furthermore, as a result of analysis of the SnCoC-containing material by XPS, a peak P1 was obtained. As a result of analysis of this peak P1, a peak P2 of surface contamination carbon and a peak P3 of C1s in the SnCoC-containing material on the side of lower energy than that of the former were obtained. This peak P3 was obtained in a region lower than 284.5 eV. That is, it was confirmed that the carbon in the SnCoC-containing material was bonded to other element.

In the case of providing the negative electrode active material layer 52B, first of all, 80 parts by mass of an SnCoC-containing material powder as a negative electrode material, 11 parts by mass of graphite and 1 part by mass of acetylene black as a negative electrode conductive agent and 8 parts by mass of polyvinylidene fluoride as a negative electrode binder were mixed to form a negative electrode mixture, which was then dispersed in N-methyl-2-pyrrolidone to prepare a negative electrode mixture slurry. Subsequently, the negative electrode mixture slurry was uniformly coated on one surface of the negative electrode collector 34A made of an electrolytic copper foil (thickness: 10 μm), dried and finally subjected to compression molding by a roll press. On that occasion, the thickness of the positive electrode material layer 33B was regulated such that the charge and discharge capacity of the negative electrode 34 was larger than the charge and discharge capacity of the positive electrode 33, thereby making a lithium metal not deposit on the negative electrode 34 at the time of full charge.

Subsequently, fluoroethylene carbonate (FEC), ethylene carbonate (EC) and diethyl carbonate (DEC) were mixed as a solvent, into which was then dissolved lithium hexafluorophosphate (LiPF₆) as an electrolyte salt, thereby preparing an electrolytic solution. On that occasion, a composition of the solvent (FEC/EC/DEC) was regulated at Oct. 25, 1965 in terms of a mass ratio, and a concentration of lithium hexafluorophosphate in the electrolytic solution was regulated at 1 mole/kg.

The evaluation results of the obtained non-aqueous electrolytic solution secondary batteries are shown in Table 3. In Comparative Example 3-2, a non-aqueous electrolytic solution secondary battery was prepared in the same manner as in Comparative Example 3-1, except that tetrabutylamine was added in an amount of 1% (on a mass basis) relative to the electrolytic solution of Comparative Example 3-1.

TABLE 3

| | | | Discharge | Swelling amount |
|---|---|---|---|---|
| | Positive | Electrolytic solution | capacity | after 4 hours |
| | electrode | additive | retention rate | (mm) |
| Example 3-1 | Compound A | | 94 | 1.08 |
| Example 3-2 | Compound A | Propene sultone | 93 | 0.88 |
| Example 3-3 | Compound A | Propane-disulfonic | 96 | 0.90 |
| | | anhydride | | |
| Example 3-4 | Compound A | Succinic anhydride | 94 | 0.89 |
| Example 3-5 | Compound A | LiBF₄ | 93 | 0.89 |
| Example 3-6 | Compound B | | 94 | 0.97 |
| Example 3-7 | Compound C | | 93 | 1.20 |
| Example 3-8 | Compound D | | 93 | 1.26 |
| Comparative | Untreated | | 93 | 1.95 |
| Example 3-1 | | | | |
| Comparative | Untreated | Added 1% | 86 | 3.80 |
| Example 3-2 | | tetrabutylamine | | |

As shown in Table 3, in the case of providing the negative electrode active material layer 34B by using the SnCoC-containing material as the negative electrode active material and adopting a coating process, the same results as those in Table 1 were obtained. That is, in Examples 3-1 to 3-8 in which the positive electrode film 33C containing the compound represented by the formula (1) was provided, not only the discharge capacity retention rate was high, but the swelling was suppressed as compared with Comparative Examples 3-1 to 3-2 in which the positive electrode film 33C containing the compound represented by the formula (1) was not provided.

### Examples 4-1 to 4-2

Non-aqueous electrolytic solution secondary batteries were prepared in the same procedures as in Examples 1-1 and 1-8, except that LiNi₀.8Co0.₂O₂ was used as the positive electrode active material in place of the LiCO_{0.98}Al_{0.01}Mg_{0.01}O₂, and then evaluated in the same manner (the negative electrode was the same as in Example 1-1, etc.).

### Examples 4-3 to 4-6 and Comparative Examples 4-1 to 4-2

Non-aqueous electrolytic solution secondary batteries were prepared in the same procedures as in Examples 2-1, 2-6 to 2-8 and Comparative Examples 2-1 to 2-2, except that the same positive electrode active material as in Example 4-1 was used and that the positive electrode film 33C was provided on the positive electrode active material layer in place of providing the film made of the metal salt on the surface of the granular positive electrode active material, and then evaluated in the same manner (the negative electrode was the same as in Example 2-1, etc.; and the swelling amount was changed to one after 12 hours). Example 4-3 is corresponding to Example 2-1; Examples 4-4 to 4-6 are corresponding to Examples 2-6 to 2-8, respectively; and Comparative Examples 4-1 to 4-2 are corresponding to Comparative Examples 2-1 to 2-2, respectively. In the case of providing the positive electrode film 33C, a 3% aqueous solution of Compound A, Compound B, Compound C or Compound D was prepared, and the positive electrode collector having the positive electrode active material layer 33B provided thereon was lifted up from the solution and then dried in a vacuum atmosphere at 150° C.

The evaluation results are shown in Table 4.

TABLE 4

| | | | Discharge | Swelling amount |
|---|---|---|---|---|
| | Positive | Electrolytic solution | capacity | after 12 hours |
| | electrode | additive | retention rate | (mm) |
| Example 4-1 | Compound A | | 94 | 1.08 |
| Example 4-2 | Compound B | | 93 | 1.05 |
| Example 4-3 | Compound A | | 93 | 0.98 |
| Example 4-4 | Compound B | | 93 | 0.99 |
| Example 4-5 | Compound C | | 93 | 1.51 |
| Example 4-6 | Compound D | | 93 | 2.22 |
| Comparative | Untreated | | 93 | 5.02 |
| Example 4-1 | | | | |
| Comparative | Untreated | Added 1% | 86 | 6.05 |
| Example 4-2 | | tetrabutylamine | | |

While the present application has been described with reference to some embodiments and working examples, the present application is never limited to these embodiments and working examples, and various changes and modifications can be made therein.

Also, in the foregoing embodiments and working examples, with respect to the kind of the battery, the lithium ion secondary battery in which the capacity of the negative electrode is expressed on the basis of intercalation and deintercalation of lithium has been described. However, the battery according to embodiments is not always limited thereto. In the case where the negative electrode contains a negative electrode material capable of intercalating and deintercalating lithium, by making the charge capacity of the negative electrode material capable of intercalating and deintercalating lithium smaller than the charge capacity of the positive electrode, the battery according to embodiments is similarly applicable to a secondary battery in which the capacity of the negative electrode includes a capacity following the intercalation and deintercalation of lithium and a capacity following the deposition and dissolution of lithium and is expressed by the sum of these capacities.

Also, in the foregoing embodiments and working examples, with respect to the electrolyte of the battery according to embodiments, the case of using a liquid electrolyte has been described. However, electrolytes of other kinds may be used. Examples of such other electrolytes include electrolytes in a gel form; mixtures of an ionic conductive inorganic compound (for example, an ionic conductive ceramic, an ionic conductive glass, an ionic conductive crystal, etc.) and an electrolytic solution; mixtures of other inorganic compound and an electrolytic solution; and mixtures of such an inorganic compound and an electrolyte in a gel form.

Also, in the foregoing embodiments and working examples, the case where the battery structure has a structure of a laminate type has been described as an example. However, the battery according to embodiments is similarly applicable to the case where the battery structure is other structure such as a rectangular type, a coin type, a cylinder type and a button type or the case where the battery element has other structure such as a laminate structure.

Also, in the foregoing embodiments and working examples, the case of using lithium as the electrode reactant has been described. However, other elements belonging to the Group 1A (for example, sodium, potassium (K), etc.), elements belonging to the Group 2A (for example, magnesium, calcium, etc.) and other light metals (for example, aluminum, etc.) may be used. In these cases, the negative electrode material which has been described in the foregoing embodiments can also be used as the negative electrode active material.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The application is claimed as follows:

1. A positive electrode comprising:
a salt represented by the following formula (1) on the surface of an active material contained in a positive electrode active material layer provided on a positive electrode collector, or at least on the surface of the positive electrode active material layer 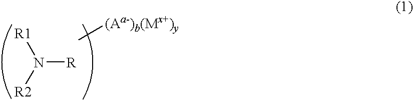
wherein R represents a hydrocarbon group which may have an unsaturated bond, a group obtained by halogenating or hydroxylating this hydrocarbon group, or a hydrogen group;
R1 and R2 each independently represents an unsaturated bond, a hydrocarbon group which may have N or O, R1 and R2 may be bonded to each other to form a ring, in which the ring may further contain N or O, or a hydrogen group; A^{a-} represents an acid anion capable of being bonded to at least any one of R, R1, R2 and the ring; M^{x+} represents a metal ion capable of forming a salt together with A^{a-}; and a, b, x and y each represents an integer of 1 or more.

2. The positive electrode according to claim 1,
wherein the salt represented by the formula (1) is a tertiary amine.

3. The positive electrode according to claim 1,
wherein A^{a-} represents SO₃⁻ or CO₂⁻.

4. The positive electrode according to claim 1,
wherein M in the formulae (1) is a metal salt belonging to the Group 1 or the Group 2 of the periodic table.

5. A battery comprising:
an electrolytic solution as well as
a positive electrode and
a negative electrode having a negative electrode active material layer provided on a negative electrode collector, wherein
the positive electrode is the positive electrode according to claim 1.

6. The battery according to claim 5, wherein the negative electrode active material layer contains a negative electrode active material containing at least one member selected from the group consisting of a simple substance of silicon, an alloyed silicon, a silicon compound, a simple substance of tin, an alloyed tin, and a tin compound.

7. The battery according to claim 5, wherein
the electrolytic solution contains a solvent containing at least one member of a chain carbonate containing a halogen, which is represented by the following formula (7), and a cyclic carbonate containing a halogen, which is represented by the following formula (8): 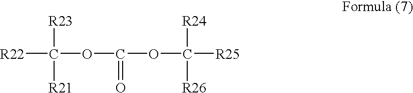
wherein R21 to R26 each represents a hydrogen group, a halogen group, an alkyl group or a halogenated alkyl group, provided that at least one of R21 to R26 is a halogen group or a halogenated alkyl group; and 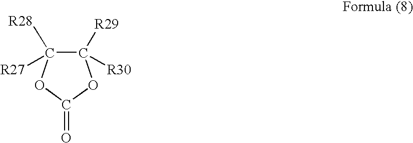
wherein R27 to R30 each independently represents a hydrogen group, a halogen group, an alkyl group or a halogenated alkyl group, provided that at least one of R27 to R30 is a halogen group or a halogenated alkyl group.

8. The battery according to claim 7, wherein
the chain carbonate containing a halogen, which is represented by the formula (7), is at least one member of fluoromethylmethyl carbonate, difluoromethylmethyl carbonate and bis(fluoromethyl) carbonate; and
the cyclic carbonate containing a halogen, which is represented by the formula (8), is at least one member of 4-fluoro-1,3-dioxolan-2-one and 4,5-difluoro-1,3-dioxolan-2-one.

9. The battery according to claim 5, wherein
the electrolytic solution contains a solvent containing a sultone.

10. The battery according to claim 5, wherein
the electrolytic solution contains a solvent containing an acid anhydride.

11. The battery according to claim 5, wherein
the electrolytic solution contains an electrolyte salt containing at least one member of lithium hexafluorophosphate (LiPF₆), lithium tetrafluoroborate (LiBF₄), lithium perchlorate (LiClO₄) and lithium hexafluoroarsenate (LiAsF₆).

12. The battery according to claim 5, wherein
the electrolytic solution contains an electrolyte salt containing at least one member of compounds represented by the following formulae (11) to (13): 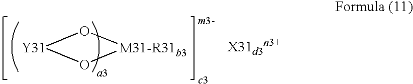
wherein X31 represents an element belonging to the Group 1 or the Group 2 of the long form of the periodic table or aluminum; M31 represents a transition metal or an element belonging to the Group 13, the Group 14 or the Group 15 of the long form of the periodic table; R31 represents a halogen group; Y31 represents —OC—R32-CO—, —OC—C(R33)₂— or —OC—CO—; R32 represents an alkylene group, a halogenated alkylene group, an arylene group or a halogenated arylene group; R33 represents an alkyl group, a halogenated alkyl group, an aryl group or a halogenated aryl group; a3 represents an integer of from 1 to 4; b3 represents an integer of 0, 2 or 4; and c3, d3, m3 and n3 each represents an integer of from 1 to 3; 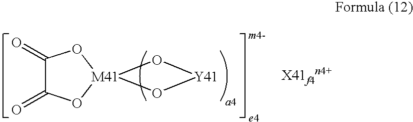
wherein X41 represents an element belonging to the Group 1 or the Group 2 of the long form of the periodic table; M41 represents a transition metal or an element belonging to the Group 13, the Group 14 or the Group 15 of the long form of the periodic table; Y41 represents —OC—(C(R41)₂)_{b4}—CO—, —(R43)₂C—(C(R42)₂)_{c4}—CO—, —(R43)₂C—(C(R42)₂)_{c4}—C(R43)₂—, —(R43)₂C—(C(R42)₂)_{c4}—SO₂—, —O₂S—(C(R42)₂)_{d4}—SO₂— or —OC—(C(R42)₂)_{d4}—SO₂—; R41 and R43 each represents a hydrogen group, an alkyl group, a halogen group or a halogenated alkyl group, and at least one of R41 and R43 is a halogen atom or a halogenated alkyl group; R42 represents a hydrogen group, an alkyl group, a halogen group or a halogenated alkyl group; a4, e4 and n4 each represents an integer of 1 or 2; b4 and d4 each represents an integer of from 1 to 4; c4 represents an integer of from 0 to 4; and f4 and m4 each represents an integer of from 1 to 3; and 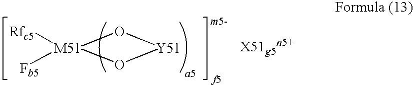
wherein X51 represents an element belonging to the Group 1 or the Group 2 of the long form of the periodic table; M51 represents a transition metal or an element belonging to the Group 13, the Group 14 or the Group 15 of the long form of the periodic table; Rf represents a fluorinated alkyl group or a fluorinated aryl group each having from 1 to 10 carbon atoms; Y51 represents —OC—(C(R51)₂)_{d5}—CO—, —(R52)₂C—(C(R51)₂)_{d5}—CO—, —(R52)₂C—(C(R51)₂)_{d5}—C(R52)₂—, —(R52)₂C—(C(R51)₂)_{d5}—SO₂—, —O₂S—(C(R51)₂)ₑ₅—SO₂— or —OC—(C(R51)₂)ₑ₅—SO₂—; R51 represents a hydrogen group, an alkyl group, a halogen group or a halogenated alkyl group; R52 represents a hydrogen group, an alkyl group, a halogen group or a halogenated alkyl group, and at least one of R52 is a halogen group or a halogenated alkyl group; a5, f5 and n5 each represents an integer of 1 or 2; b5, c5 and e5 each represents an integer of from 1 to 4; d5 represents an integer of from 0 to 4; and g5 and m5 each represents an integer of from 1 to 3.

13. The battery according to claim 12, wherein
the compound represented by the formula (11) is at least one member selected from the group consisting of compounds
represented by the following formula (14);
the compound represented by the formula (12) is at least one member selected from the group consisting of the following formula (15); and
the compound represented by the formula (13) is a compound represented by the following formula (16):

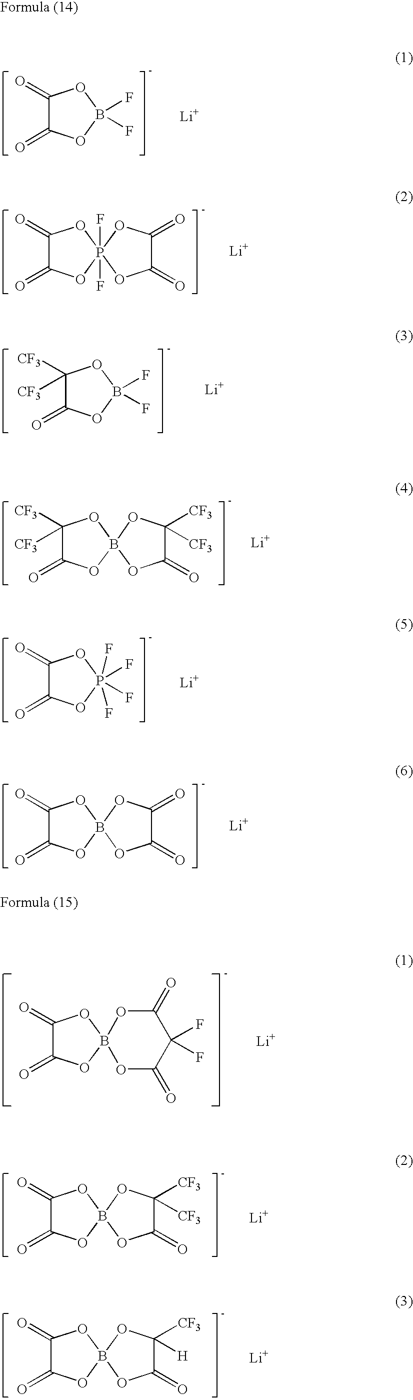

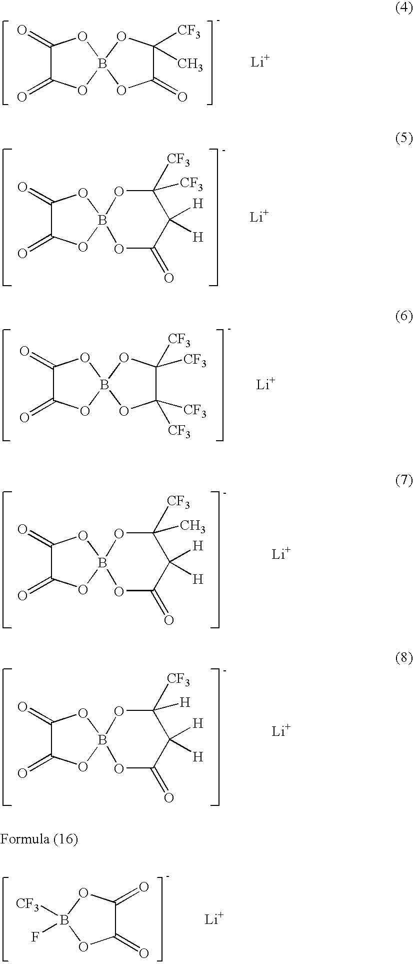

14. The battery according to claim 5, wherein
the electrolytic solution contains an electrolyte salt containing at least one member selected from the group consisting of compounds represented by the following formulae (17) to (19):
LiN(CₘF₂ₘ₊₁SO₂)(CₙF₂ₙ₊₁SO₂) Formula (17)
wherein m and n each represents an integer of 1 or more; 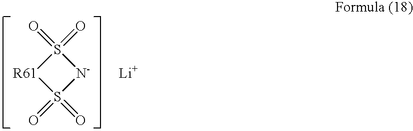
wherein R61 represents a linear or branched perfluoroalkylene group having 2 or more and not more than 4 carbon atoms; and
LiC(CₚF₂ₚ₊₁SO₂)(C_{q}F_{2q+1}SO₂)(CᵣF₂ᵣ₊₁SO₂) Formula (19)
wherein p, q and r each represents an integer of 1 or more.
